(19) United States
(12) Patent Application Publication
(10) Pub. No.: US 2022/0089956 A1
(43) Pub. Date: Mar. 24, 2022

(54) EXTRACTION AND RECOVERY OF ORGANIC MATTER USING IONIC LIQUIDS

(71) Applicant: ADJACENCY LABS CORP., Calgary (CA)

(72) Inventors: Brian W. BAILLIE, Calgary (CA); Paula BERTON, Calgary (CA); Robin D. ROGERS, Tuscaloosa, AL (US); Steven L. BRYANT, Calgary (CA)

(73) Assignee: ADJACENCY LABS CORP., Calgary, AB (CA)

(21) Appl. No.: 17/282,146

(22) PCT Filed: Oct. 3, 2019
(86) PCT No.: PCT/CA2019/051424

§ 371 Date: Apr. 1, 2021

Related U.S. Application Data
(60) Provisional application No. 62/741,199, filed on Oct. 4, 2018.

(51) Int. Cl. C10G 1/04; B01D 11/02

(52) U.S. Cl. CPC C10G 1/042; B01D 11/0288; B01D 11/0257; B01D 11/028

(57) ABSTRACT

A process for the mobilization and extraction of organic matter such as kerogen from solids such as oil shale using ionic liquid. An ionic liquid is a salt in the liquid state which has a melting point below 200° C. The process may be carried out in a subsurface reservoir or at the surface.

### FIELD OF THE INVENTION

The invention relates to using ionic liquids to solubilise, extract, mobilize, and recover organic matter from rock deposits. In particular, the invention relates to using ionic liquids to extract kerogen from oil shale.

### BACKGROUND

Oil shale is any sedimentary rock containing various amounts of solid organic material that yields petroleum products, along with a variety of solid by-products, when subjected to pyrolysis (Encyclopedia Britannica, www.britannica.com/science/oil-shale). The organic material (OM) contained in oil shales and other sedimentary deposits comprises kerogen and a small fraction of smaller molecules trapped in the kerogen.

Kerogen is a solid, heterogeneous mixture of organic material derived from ancient biomass and may be considered as immature petroleum. Kerogen is the dispersed organic material of ancient sediments insoluble in the usual organic solvents, in contrast to extractable organic material. Accordingly, petroleum (and more generally bitumen) is soluble in the usual organic solvents, whereas kerogen is the sedimentary organic material insoluble in these solvents (Vandenbroucke & Largeau Org. Geochem. 2007, 38, 719-833—a more detailed bibliography is provided at the end of the Background section).

The traditional processing of oil shale to produce oil is through pyrolysis, i.e., the thermal decomposition (>300° C.) of organic compounds comprising kerogen under anoxic conditions in which large organic molecules “crack” into smaller vapor phase organics. The lighter vapor phase hydrocarbons produced through pyrolytic processes are recovered by condensation and fractionation. De-sulfurization and hydro treating are usually required to convert typically unstable pyrolysis oil into saleable products (Vandenbroucke & Largeau, Org. Geochem. 2007, 38, 719-833).

Oil shale deposits occur worldwide, with significant deposits found in the United States, China, Jordan, Estonia, Thailand, Russia, Australia and many other locations. A 2016 estimate of potential oil shale hydrocarbons (kerogen sourced/oil in place) was more than 6 trillion barrels worldwide (“World Energy Resources”, World Energy Council, 2016) as compared with 1.6 trillion barrels of proven worldwide reserves of conventional and unconventional oil. Many kerogen-rich oil shales are too deep to be mined economically.

There are few economically viable technologies that have been developed to recover subsurface kerogen at this time. The most utilized commercial technology for producing hydrocarbons from oil shales (both historically and currently) involves mining, crushing, and high temperature pyrolysis of the crushed oil shale in retort type processes. The products of this process include shale oil condensed from the vapor phase organics, non-condensable gases (C₁-C₆, CO, and sulfides), combustion gases (CO₂, NO_{X}, SO_{X}) and residual coked solids (tailings). Examples of these technologies include the Taciuk Process (Canada), Petrobras Petrosix Technology (Brazil), and the Shale Tech Paraho 2 Process (USA).

For in situ extraction, the evaluated method is in situ retorting, where different heating strategies, sometimes in combination with the injection of solvents, were reported to heat the rock and produce subsurface hydrocarbons through in situ pyrolysis, with a view to recovering the produced liquid petroleum. Such strategies include injecting super-heated steam or air is injected (U.S. Pat. No. 5,058,675), a mixture of gas and air is pumped into the deposit and ignited ignition (Kvapil & Clews 1978 U.S. Pat. No. 4,153,299A), electromagnetic heating (Stresty et al. 1984 U.S. Pat. No. 4,485,869A), radio frequency heating (Kasevich et al 1981 U.S. Pat. No. 4,301,865A), or electrical heating (Kasevich et al. 1977 U.S. Pat. No. 4,140,179, Berchenko et al. 2001 U.S. Pat. No. 7,225,866B2; Vinegar et al. 2004 U.S. Pat. No. 6,715,547B2; Thomas & Wigand 2011 U.S. Pat. No. 9,033,033B2) are used. For electrical heating technologies, a ground-freezing technology to establish an underground barrier around the perimeter of the extraction zone is also envisioned to prevent groundwater from entering and the petroleum products from leaving.

The use of organic solvents has been extensively studied for kerogen extraction, although the percentage of extractable organic matter from oil shale deposits using different organic solvents is small and does not exceed 5 wt %. On the other hand, numerous patent documents encompass solvent extraction of oil shales using either super-heated solvents and/or super critical fluids in combination with external energy sources such as microwaves or ultrasonic energy to extract the kerogen. Examples include the use of supercritical toluene in combination with a hydrogen donor (Shaw 2006 WO2008061304A1) supercritical CO₂ (Looney et al. 2006 WO2007098370A2) or hot solvents heated at high temperature but lower than 400° C., the thermal degradation temperature of the oil shale (Maaten et al. 2016). Solvents like pyridine or tetrahydrofuran can destroy the non-covalent interactions within the macromolecular matrix, although their performance is highly dependent on the chemical structure of the oil shales (Koel et al. Ionic Liquids for Oil Shale Treatment, In: Rogers et al. (eds.) Green Industrial Applications of Ionic Liquids 2003, 193-208). Another example of heated solvents includes the use of molten salt media (i.e., salts molten at temperatures higher than 300° C.); Bugle et al. used a basic tetrachloroaluminate melt to dissolve Green River oil shale, achieving a conversion of 58% of organic carbon at 320° C., through both thermal and catalytic degradation (Bugle et al. Nature 1978, 274, 578-580; Plummer 1984 U.S. Pat. No. 4,555,327A), while Meyers and Hart reported 80-95% kerogen extraction when fused alkali metal caustic to remove the sulfur content and release the foreign mineral matter from the hydrocarbon material (Meyers & Hart 1981 U.S. Pat. No. 4,545,891).

Ionic liquids (ILs) can be used to extract kerogen from reservoirs, such as oil shales. Existing references citing kerogen extraction methods that utilize Ionic Liquids are limited and merely exploratory. Demineralised kerogen was shown to dissolve in the acidic Ionic Liquid, 1-ethyl-3-methylimidazolium chloride/aluminum (III) chloride ([C₂mim]Cl.AlCl₃), where the mole fraction of AlCl₃ was 0.65 (Patell et al. The Dissolution of Kerogen in Ionic Liquids, In: Rogers et al. (eds.) Green Industrial Applications of Ionic Liquids 2003, 499-510). Samples were demineralized with hydrochloric/hydrofluoric acid and dried thoroughly before treatment with the Ionic Liquid. Dissolution of up to 95% of the kerogens occurred and treatment under microwave irradiation improved the process. However, all manipulations of the Ionic Liquid, including kerogen extraction, were carried out in a high quality inert-atmosphere due to the extreme air and moisture sensitivity of the Ionic Liquids, mainly the nature of the anion, used.

Koel et al. evaluated the use of the Ionic Liquids 1-butyl-3-methylimidazolium hexafluorophosphate ([C₄mim][PF₆]), which is relatively moisture insensitive (but subject to hydrolysis) and the air and moisture sensitive 1-butyl-3-methylimidazolium chloride/aluminum(III) chloride ([C₄mim]Cl.AlCl₃) system for kerogen extraction from Estonian oil shales (Koel et al. Pure Appl. Chem. 2001, 73, 153-159). The [C₄mim][PF₆] Ionic Liquid was a poor solvent (below 0.1% from total mass of shale taken), with better results being obtained with the [C₄mim]Cl.AlCl₃ Ionic Liquids (although still below 0.3% from total mass of shale taken). With the latter, no evidence of extraction was observed at room temperature, but the extraction yield of soluble products was increased to 1.7-4% from total mass of shale taken), ten-fold over that obtained using conventional organic solvents (hexane and dichloromethane) (Koel et al. Pure Appl. Chem. 2001, 73, 153-159).

### BIBLIOGRAPHY

### Patent Documents

U.S. Pat. No. 7,225,866, Jun. 5, 2007, Berechenko at al.
U.S. Pat. No. 4,140,179, Feb. 20, 1979, Kasevich et al.
U.S. Pat. No. 4,153,299, May 8, 1979, Kvapil et al.
U.S. Pat. No. 4,545,891, Oct. 8, 1985, Meyers et al.
U.S. Pat. No. 4,555,327, Nov. 26, 1985, Plummer.
U.S. Pat. No. 9,033,033, May 19, 2015, Thomas et al.
U.S. Pat. No. 5,058,675, Oct. 22, 1991, Travis.
U.S. Pat. No. 6,715,547, Apr. 6, 2004, Vinegar et al.
WO 2007/098370, Aug. 30, 2007, Looney et al.
WO 2008/061304, May 29, 2008, Shaw.

Articles
Bugle et al., “Oil-shale kerogen: low temperature degradation in molten salts” Nature, Vol. 274, Aug. 10, 1978, pp. 578ff.
Koel et al., “Using neoteric solvents in oil shale studies” Pure Appl. Chem., Vol. 73, No. 1, pp 153ff, 2001.
Koel et al., “Ionic Liquids for Oil Shale Treatment” Green Industrial Applications for Ionic Liquids, pp. 193ff., 2003.
Maaten et al., “Decomposition Kinetics of American, Chinese and Estonian Oil Shales Kerogen” Oil Shale, 2016, Vol. 33, No. 2, pp 167ff.
Patell et al., “The Dissolution of Kerogen In Ionic Liquids” Green Industrial Applications of Ionic Liquids, pp. 499ff., 2003.
Vandenbroucke and Largeau “Kerogen origin, evolution and structure” Organic Geochemistry 38, 2007, pp. 719ff.

Miscellaneous Documents
“World Energy Resources 2016” World Energy Council, Resources 2016, URL: https://www.worldenergy.org/assets/images/imported/2016/10/World-Energy-Resources-Full-report-2016.10.03.pdf

### SUMMARY

The present disclosure provides a process for extracting organic matter (OM) insoluble in traditional solvents from solids containing such hydrocarbons such as oil shale.

According to the present disclosure there is provided a process for extracting organic matter insoluble in dichloromethane, toluene and hexane from solids, the process comprising:

combining organic-matter-containing solids and an ionic-liquid-enriched solvent comprising an ionic liquid such that organic matter from the organic-matter-containing solids is transferred into the ionic-liquid-enriched solvent to form a liquid phase comprising the ionic-liquid-enriched solvent and transferred organic matter;

separating the liquid phase from the solid phase; and

recovering the organic matter from the liquid phase.

The organic matter may comprise kerogen.

The organic-matter-containing solids may be oil shale.

The ionic liquid may be stable in the presence of moisture.

The combining of the organic-matter-containing solids and an ionic-liquid-enriched solvent is performed at a temperature of in the range of between 20 and 200° C. (e.g. between 120 and 200° C.). The combining of the organic-matter-containing solids and an ionic-liquid-enriched solvent may be performed at a temperature above the melting point of the ionic liquid.

The melting point of the ionic liquid may be less than 200° C.

The solvent may comprise an organic solvent. The solvent may comprise one or more of: a hydrogen donor and oxidant agent.

The ionic liquid comprises one or more cations selected from the group consisting of: sulfonium, phosphonium, imidazolium, pyridinium, ammonium.

The process may comprise contacting the organic matter with a swelling agent. The process may comprise drying the organic-matter-containing solids before combining with the ionic-liquid-enriched solvent. The organic-matter-containing solids may be treated with an acid agent before the ionic-liquid-enriched solvent is combined with the organic-matter-containing solids. The process may comprise combining the solids with an acid to dissolve and recover metals.

Recovering the organic matter may comprise precipitating the organic matter from the liquid phase.

The process may comprise:

injecting the ionic-liquid-enriched solvent downhole to combine the ionic-liquid-enriched solvent with subsurface organic-matter-containing solids;

pumping the liquid phase to the surface to separate the liquid phase from the solid phase.

The process may comprise crushing the organic matter containing solids prior to adding an ionic-liquid-enriched solvent.

The process may comprise crushing the organic-matter-containing solids to particles in a size range of 200-500 microns.

According to a further aspect, there is provided the use of a moisture-stable ionic liquid for solubilisation or mobilization of an organic fraction which is insoluble in dichloromethane, toluene and hexane and which is thermally convertible into petroleum products.

In the context of this invention, organic matter may be considered insoluble in a particular solvent if less than 5 wt % is dissolved by that solvent.

The present technology may be configured to dissolve between 5-20 wt % of the total organics present in the rock. In some cases, the present technology may be configured to dissolve more than 20 wt % of the total organics present in the rock. The present technology may be configured to dissolve between 5-100 wt % of the total organics which are insoluble in dichloromethane, toluene and hexane.

The process may be performed at surface or in a subsurface reservoir.

The surface process may supplying crushed organic-material-containing solids, such as oil shale, and an ionic liquid solvent, and extracting the organic material from the organic-material-containing solids at moderate temperature and pressure into the ionic liquid solvent.

According to the present disclosure there is provided a process for extracting organic material (insoluble in traditional organic solvents such as dichloromethane, toluene and hexane) from solids containing organic material such as oil shale that includes the following steps:

(a) crushing organic-material-containing solids, such as oil shale, to a predetermined particle size distribution;

(b) supplying the crushed organic-material-containing solids, such as oil shale and an ionic liquid solvent, and extracting the organic material from the organic-material-containing solids at moderate temperature and pressure into the ionic liquid solvent;

(c) separating the organic material from the ionic-liquid-enriched phase; and

(d) processing the organic material to generate oil.

After the kerogen is extracted/mobilized, the resulting mixture may be in the form of liquid slurry or liquid solution (depending on the ionic liquid used). The ionic liquid solvent may be a pure ionic liquid comprising one or more ionic liquids. The ionic liquid solvent be a mixture of one or more ionic liquids and solvent (e.g. traditional solvents such as alkanes). Mixtures of ionic liquids and solvents may help to decrease the cost of the process and modify other properties such as viscosity.

Part of the kerogen may be mobilized in the ionic liquid phase. Mobilization may include, as well as dissolving the organic material in the ionic liquid, mobilizing some of the organic material as small particulates in the ionic liquid fluid.

The organic-material-containing solids may be oil shale or material eroded from oil shale.

The organic material present in oil shale may be kerogen and/or entrapped bitumen, not directly extractable using traditional organic solvent.

The mobilization of the organic material (e.g. kerogen) may induce physical changes in kerogen which caused the softening of kerogen and molecular rearrangement that lead to the release of the entrapped gas, such as methane, and bitumen.

The ionic liquid solvent may comprise one or more moisture-stable ionic liquids. The solvent composition may contain a percentage (up to 70%) of traditional, organic solvents (e.g. water, toluene and/or methanol). The ionic liquid solvent may consist of one or more moisture-stable ionic liquids and one or more organic solvents. The moisture-stable ionic liquids and one or more organic solvents may make up more than 95 wt % of the ionic liquid solvent.

The components of the ionic liquid(s) may be premixed prior to adding to the oil shale to the extraction step or sequentially added to the oil shale.

The ionic liquid solvent may contain hydrogen donors or oxidants incorporated in the formula of the ionic liquid, which facilitate the direct conversion of kerogen in oil shale into a hydrocarbon that is soluble in the solvent. In addition, the hydrogen donor may facilitate removal of nitrogen and sulphur. This is important in terms of ultimate product quality for petroleum companies.

The ionic liquid may have a melting point below 200° C. The ionic liquid may have a general chemical formula [Cation][Anion] wherein at least one of the Cation and Anion is a surface-active component.

The ionic liquid may have an appropriate hydrophobic/hydrophilic balance (HLB) in order to mobilize the organic matter.

At least one of the cation and anion of the ionic liquid may be a Brønsted or Lewis acid or base.

The cation may be selected from the group consisting of phosphonium, imidazolium, pyridinium, and ammonium.

The anion may be selected from the group of halogens (e.g. F⁻, Cl⁻, Br⁻, and I⁻).

The anion may be selected from of organic anions containing at least one carboxylic group and at least one sulfonate group.

The anion may be selected from consisting of halides of aluminum, zinc, tin, iron, boron, gallium, antimony, tantalum, and mixtures thereof.

The anion may comprise a pendant Brønsted-acidic group such as a sulfonic acid group.

The anion may comprise one or more anions selected from the group consisting of hydrohalogenate, triflate, sulfate, hydrosulfate, fluorinate, phosphate, and organic anions containing a pendant Brønsted-acidic group.

As illustrated in the examples below, a non-exhaustive list of suitable ionic liquids includes trihexyltetradecylphosphonium bis(trifluoromethylsulfonyl)amide ([P₆₆₆₁₄][NTf₂]) and 1-ethyl-3-methylimidazolium acetate ([C₂mim][OAc]), which are available for purchase from loLiTec in Tuscaloosa, Ala., United States, and octylammonium oleate ([C₈NH₃][Oleate]), tributylammonium oleate ([HN₄₄₄][Oleate]), N-octylammonium dodecylbenzenesulfonate ([C₈NH₃][C₁₂BenzSO₄]), triethylammonium oleate ([HN₂₂₂][Oleate], hydroxylammonium acetate ([NH₃OH][OAc], Brønsted acidic —SO₃H ionic liquid [MimSO₃H]Cl, Brønsted acidic ionic liquid [HN₂₂₂][HSO₄], Brønsted acidic ionic liquid [C₂mim][HCl₂], and Lewis acidic ionic liquid [HN₂₂₂][Al₂Cl₇], which can be synthesized using methods known in the art. The ionic liquid used for the above processes can comprise one or more of the ionic liquids listed above, or any other suitable ionic liquids. For example, in an embodiment, the ionic liquid is comprised of [HN₄₄₄][Oleate] and [C₈NH₃][Oleate] mixed together in a 1:1 weight ratio.

The solvent is contacted with oil shale under different conditions (pressure and temperature) to recover the organic fraction from the oil shale. The extraction of the organic fraction can occur in-batch or in-flow (i.e., continuously). The Ionic Liquid can be brought into contact with the shale in a continuous mode, such that Ionic Liquid is continuously being introduced and removed from the shale. Alternatively, the Ionic Liquid can contact the shale in a batch mode, such that Ionic Liquid is periodically brought into contact with the shale, permitted to remain in contact therewith for a period of time, and subsequently removed before a new batch of Ionic Liquid is introduced. This step is described by the box marked “Extraction” in the flow sheet.

The extraction temperature can be achieved within the reactor or the ionic liquid solvent may partially be heated up prior to feeding the liquids and solids into the reactor as is done in other designs, with the choice of method being dependent upon which system is most cost effective to meet the needs, especially residence time, for a given feed material.

During the period of the above-described extraction step there can be periodic release of gas from to remove volatiles, entrapped gasses, sulphur, or residual water.

At the end of the extraction step, the slurry of solids and liquids is separated in a solid-liquid separation step to extract and thereafter separate hydrocarbons from the slurry. This step is described by the box marked “Solid/Liquid Separation” in the flow sheet.

The solid/liquid separation is designed to ensure that there is minimal carry-over of solids with the organic-material-enriched solvent phase.

The ionic liquid/organic material liquid phase may be transferred into a “Flocculation” vessel, where the organic material is separated using techniques such as by increasing and/or decreasing the temperature, filtration, and/or centrifugation of the solution.

Further, an anti-solvent, precipitating agent, nanoparticles, heavy particles, and other methods known in the art, or a combination thereof may be added to the Ionic Liquid/organic material mixture to affect precipitation of organic material. The addition of an anti-solvent from the group consisting of ethanol, acetonitrile, 2-propanol, dimethyl sulfoxide, methanol, hot water/steam and mixtures thereof induces the displacement of organic material from the ionic liquid phase into a separated, organic, solid phase. For example, alcohol such as methanol or ethanol may be added to the mixture to produce a kerogen precipitate from the solution.

The flocculation can be further accelerated by increasing and/or decreasing the temperature of the solution. The mixture can then be centrifuged to collect the precipitate, which is subsequently removed. The remaining supernatant can undergo further successive treatments with alcohol to produce further kerogen precipitate, which can also be centrifuged and collected. The remaining supernatant, which substantially comprises Ionic Liquid, can be distilled to recover the Ionic Liquid such that it can be re-used to mobilize additional kerogen.

The organic material can then be thermally converted into saleable petroleum products using processes and methods known in the art. Exemplary cracking reactions include pyrolysis, partial oxidation, and fluid catalytic cracking and hydrocracking.

The process may further comprise a step of recovering the petroleum products in a suitable form, for example by any one or more of condensation and distillation, selective fractionation, and solvent extraction. The processing of the hydrocarbons extracted will vary depending upon the composition achieved for any given feed material. The boiling point ranges of the various product fractions recovered in any particular refinery or synthesis process will vary with such factors as the characteristics of the source, local markets, product prices, etc.

Preferably the crushing step crushes mined oil shale to particles in a size range of 200-500 μm. The crushing may be performed using high-pressure grinding rolls.

The process may include a step of drying the crushed oil shale produced in crushing step prior to supplying the oil shale to the extraction step. Conventional direct drying techniques with hot gases are one, although not the only, suitable option for drying the mined oil shale.

Various processes may be performed in order to enhance the dissolution, mobilization, and extraction of organic material from the shale. The Ionic Liquid can be brought into contact with the shale at various pressures and temperatures in order to increase the amount of kerogen extracted. For example, the mixture of Ionic Liquid and oil shale can be heated to up to 200° C. The Ionic Liquid and/or the shale may also be pre-heated before being brought into contact with the each other.

Depending on the characteristics, the oil shale pre-treatment may include sorting on the basis of particle size and flotation to remove undesirable components of the oil shale such as sulphur. The pre-treatment may also include washing with acidic aqueous solution to remove soluble impurities that may cause corrosion or contamination problems within a downstream reactor(s). The pre-treatment may also include drying (dewatering) of the oil shale to remove sufficient of the water (more than 70% of the water) to avoid problems in the extraction step arising from water: (a) forming an immiscible phase that causes the overall system pressure to become too high, and/or (b) dissolving out inorganic contaminants in the oil shale and becomes a source of corrosion within downstream reactors. The oil shale may be dried by any suitable direct or indirect means, including using filters for a first part of the water removal in cases where the shale has been treated in an aqueous slurry.

Additionally, extraction of the organic material can be enhanced by stirring the Ionic Liquid/shale mixture, mixing the Ionic Liquid with an organic solvent, adding an organic solvent, crushing and/or powdering the shale, increasing residence time that the Ionic Liquid is in contact with the shale, using microwaves or ultrasound, or a combination of any of the above.

The above-described method of extracting organic material from shale using ionic liquids may be applied to the in-situ recovery of organic material from an oil shale reservoir. An ionic liquid can be introduced into the shale reservoir to mobilize the kerogen therein, such as by pumping the ionic liquid into a wellbore in communication with the shale reservoir. The ionic liquid/organic material solution can then be produced to surface and collected to be processed. The Ionic Liquid/organic material solution can then be processed as above described. For example, the solution may be chilled and/or be mixed with a reagent, such as an alcohol, to initiate precipitation of the organic material. The mixture can then flow into a solid/liquid separator, such as hydrocyclones or centrifuges, to separate the organic material precipitate from the spent Ionic Liquid. The separated organic material can then be pyrolyzed and the saleable products stored or fractionated. The supernatant of the Ionic Liquid/organic material mixture can undergo further precipitating and centrifuging treatments to extract additional organic material from the solution. The remaining supernatant, comprising substantially spent Ionic Liquid and alcohol, can be distilled, such as using a vacuum distillation, to recover the alcohol and Ionic Liquid such that the Ionic Liquid may be re-introduced into the shale reservoir for mobilizing and extracting organic material, and the alcohol can be reused for precipitating organic material from additional Ionic Liquid/organic material solution. The recovered organic material can be processed as above described, at surface facilities.

Fracturing strategies, including but not limited to hydraulic fracturing, thermal fracturing, electro-static pulse fracturing, explosive fracturing, or combinations thereof may be used to increase the accessibility of the kerogen in oil shale reservoirs.

Pre-treatment of the kerogen/oil shale may include one or more of: drying the shale, acidifying the inorganic matrix, extracting the extractible organics, removing water from the formation, and circulating a solvent to swell the kerogen.

It has been observed that the organic material/kerogen extracted using the described processes may be more thermally labile than kerogen extracted by conventional means. As such, the extracted kerogen may require less energy to decompose into smaller hydrocarbons, thus providing potential cost savings in processing.

Additionally, it has been observed that the kerogen extracted using ionic liquids may contain less sulfur compounds and aromatic compounds compared with kerogen extracted via retorting, and thus have a greater commercial value. Further, the kerogen extraction process can be performed at lower temperatures relative to conventional extraction methods such as retorting.

The process may generate large quantities of solids.

The slurry of solids and liquids may be separated in a solid-liquid separation step to extract and thereafter separate the organic matter/ionic liquid mixture from the slurry.

Approaches for separation may be selected from techniques such as clarification (gravity sedimentation), thickening (hydrocyclones, cross flow filters, gravity and centrifugal sedimentation, cake filter), field assisted separation (acoustic, electric, magnetic), cake filters (cross flow, pressure, centrifugal gravity, vacuum), or a combination of these

The post-processed solids may be further processed using mineral acid (such as nitric and/or hydrochloric acid), organic acids (such as acetic acid), and or ionic liquids, or a combination thereof, to dissolve and recover valuable metals, such as uranium, nickel, vanadium and molybdenum, which can be present in these fractions. In case of using a pre-treatment step that includes acid treatment, the acid solution may also be processed to recover the dissolved valuable metals. The acidic liquor containing these metals can then be processed further to recover the metals for sale using conventional processing.

In a situation in which the organic matter-containing solids also contain valuable metals, the process may include contacting the solids separated from separation step with an acid, typically a mineral acid (such as nitric and/or hydrochloric acid), organic acids (such as acetic acid), or ionic liquids, or a combination thereof, to dissolve and recover valuable metals, such as uranium, nickel, vanadium and molybdenum, that typically are present in a solid fraction and forming a metal-containing liquor.

The process may comprise increasing accessibility of the kerogen to the fluid prior to providing the fluid to the subsurface shale formation. This means that fluids injected into the reservoir can more easily come into contact with the kerogen organic matter.

Increasing the accessibility may be performed by fracturing processes, including but not limited to hydraulic fracturing, thermal fracturing, electro-static pulse fracturing, explosive fracturing, or combinations thereof.

The process may comprise preconditioning or pre-treating the kerogen in the shale formation prior to providing the fluid to the subsurface shale formation.

The preconditioning may be a process selected from the group consisting of acidifying the inorganic matrix, extracting non-kerogen organics (e.g. natural gas, oil, bitumen), removing water from the formation, circulating a solvent to swell the kerogen, and combinations thereof. Extracting non-kerogen organics may comprise SAGD or injecting traditional solvents to dissolve the organics.

The preconditioning may comprise acidifying the material.

The inorganic material matrix may be acidified by contacting it with inorganic acids, organic acids, CO₂, CO₂ at supercritical conditions, or mixtures thereof.

The preconditioning may comprise contacting the kerogen with a swelling agent. Swelling the kerogen as pretreatment may help open the organic-material structure, making regions of the organic-material more accessible so that they can interact with the ionic liquid solvent, facilitating the extraction process.

The swelling agent may be selected from the group consisting of CO₂, CO₂ at supercritical conditions, ethanol, acetonitrile, 2-propanol, dimethyl sulfoxide, methanol, and mixtures thereof.

The preconditioning may comprise removing water from the formation prior to providing the fluid to the subsurface shale formation.

The water may be removed by circulating liquids and/or gases through the formation.

The liquids and/or gases circulated may be selected from the group consisting of ethanol, CO₂ at supercritical conditions, CO₂, or mixtures thereof.

The transfer may be performed at a temperature of in the range of between 20 and 200° C. Thermal degradation of oil shale kerogen typically occurs at temperatures of 200° C. and above.

Drying the organic-matter-containing solids may remove at least 80%, of the water from the organic-matter-containing solids by weight. Drying the organic-matter-containing solids may remove at least 90%, of the water from the organic-matter-containing solids by weight.

The solvent may comprise a hydrogen donor or oxidant agent are included in the ionic liquids composition and facilitate direct conversion of kerogen in oil and removal of nitrogen and sulphur

The solvent for use in the extraction step may be an ionic liquid, a mixture of ionic liquids, or a mixture of ionic liquids and traditional, organic solvents.

The solvent composition may contain a percentage (up to 70%) of traditional, organic solvents (from water to toluene to methanol).

The organic matter/ionic liquid solvent can be separated with the addition of an anti-solvent such as, but not limited to, ethanol, acetonitrile, 2-propanol, dimethyl sulfoxide, methanol, hot water/steam and mixtures thereof. The separation of the organic matter can be further accelerated by increasing and/or decreasing the temperature of the solution in combination with centrifugal separation.

The liquid phase may be composed mainly by the ionic liquid solvent, which can be reused either directly or after a reconditioning step.

The liquid phase may be composed mainly by the ionic liquid solvent, which can be reused after the distillation of the anti-solvent, reconditioning of the ionic liquid solvent, and a combination of these.

The organic matter may then be thermally converted into saleable petroleum products using processes and methods known in the art, such as pyrolysis, partial oxidation, fluid catalytic cracking and hydrocracking, and combinations of these.

The petroleum products may be processed into suitable forms, such as by any one or more of condensation and distillation, selective fractionation, solvent extraction, and combination of these.

Traditional solvents include one or more of the following: water, alcohol, acid, ketone, ester and alkane.

Traditional solvents include dichloromethane, toluene and hexane. Dichloromethane, toluene and hexane may be used to dissolve bitumen but not to dissolve kerogen.

Traditional solvents include one or more of the following: acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethylene glycol, diethyl ether, diglyme (diethylene glycol dimethyl ether), 1,2-dimethoxy-ethane (glyme, DME), dimethyl-formamide (DMF), dimethyl sulfoxide (DMSO), 1,4-dioxane, ethanol, ethyl acetate, ethylene glycol, glycerin, heptane, Hexamethylphosphoramide (HMPA), Hexamethylphosphorous triamide (HMPT), hexane, methanol, methyl t-butyl ether (MTBE), methylene chloride, N-methyl-2-pyrrolidinone (NMP), nitromethane, pentane, Petroleum ether (ligroine), 1-propanol, 2-propanol, pyridine, tetrahydrofuran, toluene, triethyl amine, water, heavy water, o-xylene, m-xylene, and p-xylene.

Moderate pressures may comprise pressures between ambient (e.g. 1 kPa) to pressures below fracturing pressure of the rock (which will depend on the oil shale but may be up to 60,000 kPa).

Kerogen is a naturally occurring, solid, insoluble organic matter that occurs in source rock. Kerogen is the portion of naturally occurring organic matter that is non-extractable using organic solvents. Typical organic constituents of kerogen are algae and woody plant material. Kerogens have a high molecular weight relative to bitumen, or soluble organic matter. Kerogens are described as:
Type I, consisting of mainly algal and amorphous (but presumably algal) kerogen and highly likely to generate oil;
Type II, mixed terrestrial and marine source material that can generate waxy oil; and
Type III, woody terrestrial source material that typically generates gas.

Kerogen may comprise mainly hydrocarbon compounds by mass. Kerogen may comprise mainly paraffin hydrocarbons by mass, though the solid mixture may also incorporates nitrogen and sulfur. Kerogen may be insoluble in water and in organic solvents such as benzene or alcohol.

Carbon in kerogen may range from almost entirely aliphatic (spa hybridized) to almost entirely aromatic (sp² hybridized). The skeletal density of kerogen may range from approximately 1.1 g/ml to 1.7 g/ml. Kerogen may have a molecular weight of above 1,000 g/mol.

According to a further aspect there is provided, the use of an ionic liquid or a mixture of ionic liquids for solubilisation/mobilization of an organic fraction insoluble in traditional organic solvents and that can be thermally converted into petroleum products.

The organic fraction may be in an oil shale and that, when the oil shale is contacted with an ionic liquid or a mixture of ionic liquids, at least a portion of the organic fraction present in the oil shale is mobilized and extracted.

The ionic liquid may have a melting point below 200° C. The ionic liquid may have the general formula [Cation][Anion], wherein the [Cation], [Anion], or both are defined as surface active components. The [Cation] may comprise one or more cations selected from the group consisting of sulfonium, phosphonium, imidazolium, pyridinium, and ammonium (from a primary, secondary, tertiary, or quaternary amine); and the [Anion] may comprise one or more anions selected from the group consisting of halogens (F⁻, Cl⁻, Br⁻, I⁻), or organic anions containing at least one carboxylic group or at least one sulfonate group.

The ionic liquid may be a Brønsted or Lewis acid or base and reacts with at least a portion of the organic fraction insoluble in traditional solvents when used pure or in a mixture.

The ionic liquid may have a melting point below 200° C. and the general formula [Cation][Anion], wherein the [Cation], [Anion], or both are defined as Brønsted or Lewis acid or base.

The ionic liquid or a mixture of ionic liquids may be mixed with a Brønsted acid at different proportions and the mixture is contacted with the oil shale or the insoluble organic matter in a batch or continuous mode.

The ionic liquid or a mixture of ionic liquids may be contacted with the oil shale or the insoluble organic matter in a batch mode and the dissolution, mobilization, and extraction of the organic fraction are enhanced by stirring, powdering the shale, increasing contact time, modifying the temperature and pressure, or a combination of these.

The ionic liquid or a mixture of ionic liquids may be contacted with the oil shale or the insoluble organic matter in a continuous mode and the dissolution, mobilization, and extraction of the organic fraction are enhanced by residence time, powdering the shale, modifying the temperature and pressure, or a combination of these.

The ionic liquid or mixture of ionic liquids and organic fraction may be separated using techniques such as temperature, filtration, centrifugation, addition of anti-solvent, nanoparticles, or heavy particles, or a combination of these.

In the context of the present application, various terms are used in accordance with what is understood to be the ordinary meaning of those terms.

An ionic liquid (IL) is a salt in the liquid state. In the context of this disclosure, an ionic liquid is a salt which may have a melting point below 200° C. The ionic liquid may have a melting point below 150° C.

The Ionic Liquid may be insoluble in water and soluble in non-polar organic solvent, soluble in water and soluble in non-polar organic solvent, or soluble in water and insoluble in non-polar organic solvent.

The Ionic Liquid may be a surface-active ionic liquid. The term “surface active ionic liquid” includes ionic liquids which contain at least one ion with amphiphilic character under certain conditions. Surface active ionic liquids have surfactant-like properties. In various embodiments, both ions of the surface-active ionic liquid have amphiphilic character. Examples of surface-active ionic liquids include octylammonium oleate, triethylammonium oleate, and tributylammonium oleate.

Oil shale may be considered to be an organic-rich fine-grained sedimentary rock containing kerogen. Fine-grained sedimentary rock may be made up of silt (0.004-0.0625 mm) and clay size particles (<0.004 mm).

As used herein, the terms “about” and “approximately” refer to a certain variation from a given value. It is to be understood that such a variation is always included in any given value provided herein, whether or not it is specifically referred to.

While various embodiments have been described in detail, it is apparent that modifications and adaptations of those embodiments will occur to those skilled in the art.

### DESCRIPTION OF THE FIGURES

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a schematic showing the extraction process.

FIG. 2 is a schematic showing the in-situ process.

FIGS. 3a and 3b shows a fresh Surface of Un-Extracted Stuart Oil Shale 3400× and 2000× magnification.

FIG. 3c shows Fresh Surface of Un-Extracted Green River Oil Shale (2500× magnification).

FIG. 4 is Modified Fischer Assay Apparatus.

FIG. 5 is an example of GC-MS total ion chromatograph.

FIG. 6 is a graph of the refractive index.

FIG. 7a shows the reaction of oil shale with [Mim-SO₃H]Cl Ionic Liquid;

FIG. 7b is a photo showing the result of the mixing of oil shale with the conventional solvent, Toluene.

FIG. 8a shows the supernatant after microwave treatment of Stuart oil shale with [C₂mim][OAc].

FIG. 8b shows the supernatant after microwave treatment of Jordanian oil shale with [C₂mim][OAc].

FIG. 9 shows the Mini Rig Setup.

FIG. 10 shows the Qualitative (Visual) Extraction of Kerogen.

FIG. 11 shows the Precipitation of Kerogen Out of Ionic Liquid.

FIG. 12 shows Precipitated kerogen from 1 mL eluent.

FIGS. 13a-b are GC-MS chromatograms of the produced Shale Oil (Stuart Oil Shale), top) sample recovered from the receiver; and bottom) Shale Oil (reflux) recovered from the quartz sand phase.

FIG. 14 is a GC-MS Total Ion Chromatograph of Vapor Impinger Oil.

FIG. 15 is a Fraction/Boiling Point Distribution of Vapor Impinger Oil.

FIG. 16 is the GC-MS Total Ion Chromatograph of Produced Oil.

FIG. 17 is the Fraction/Boiling Point Distribution of Produced Oil.

### DETAILED DESCRIPTION

While the Ionic-Liquid-based chloroaluminate discussed above showed potential to extract/mobilize kerogen from oil shale, it is highly hygroscopic and reactive with water and air, which contains moisture. When these Ionic Liquids are exposed to water, their catalytic properties are lost since the anion reacts with water to generate aluminum oxide, and/or aluminum hydroxide species, and the corrosive hydrochloric acid (HCl). This feature of Ionic Liquids-based chloroaluminates means that they must be handled carefully to prevent exposure to moisture and air, usually in a glove box. As air and moisture are ubiquitous in the mining and/or extraction of kerogen from oil shale, a solvent that is less sensitive to these environments, or a method of controlling the environment to exclude air and moisture, is desirable.

The present disclosure describes the use of moisture-stable Ionic Liquids with solvent properties and/or moisture-stable reactive Ionic Liquids to mobilize kerogen from a variety of oil shale sources. The selected Ionic Liquids are designed to interact with polar fractions of bitumen/kerogen and/or to react with bitumen/kerogen at ambient conditions (in presence of air and/or moisture). It is further suggested that these Ionic Liquids can be utilized in an in-situ reservoir flood type process in which kerogen is recovered from these Ionic Liquids and converted into petroleum while the Ionic Liquids are recycled for re-use.

### Surface Process

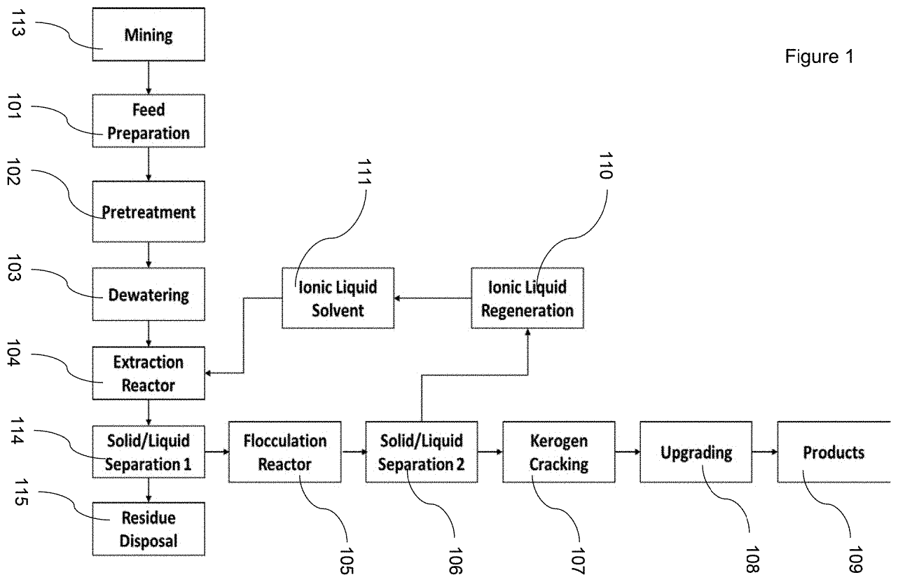

FIG. 1 is a flow chart for a surface process for extracting organic matter insoluble in traditional solvents such as dichloromethane, toluene and hexane from solids (e.g. rock particles).

In this case, the solids are oil shale rocks containing kerogen organic matter. The oil shale is mined 113 to bring the organic-matter-containing solids to the surface. In this case, the mining is surface mining, but other embodiments may use high-wall or underground mining.

Once the organic-matter-containing solids are at the surface they are prepared 101. This preparation 101 comprises breaking the solids up into smaller particulates. This increases the surface area to volume ratio of the solids which may help allow any treatment to better access the organic matter. In this case, the rock is ground to a particle size range of 200-500 microns. This size range may be particularly suitable for forming a slurry in the extraction step that can be pumped. This size range may also be large enough to facilitate removing the particulates at a later stage in the process. The particles may be separated using a mesh with a size between 200-500 microns. Larger particulates may be subjected to further grinding.

In this case, the particles are pre-treated prior to combining with the ionic-liquid solvent. the pre-treatment 102 includes flotation to remove undesirable components of the oil shale such as sulphur and washing with acidic aqueous solution to remove soluble impurities that may cause corrosion or contamination problems within a downstream reactor(s).

After the pre-treatment stage, the solids are dried (dewatered 103). This may help avoid problems in the extraction step arising from water. Water may form an immiscible phase that causes the overall system pressure to become too high, and/or dissolve out inorganic contaminants in the oil shale and becomes a source of corrosion within downstream reactors. The oil shale may be dried by any suitable direct or indirect means, including using filters for a first part of the water removal in cases where the shale has been treated in an aqueous slurry. The drying may be configured such that water represents less than 10% of the total mass of water plus organic materials.

After the solids have been dewatered, the process comprises combining organic-matter-containing solids and an ionic-liquid-enriched solvent comprising an ionic liquid such that the organic matter from the organic-matter-containing solids are transferred into the ionic-liquid-enriched solvent to form a liquid phase comprising the ionic-liquid-enriched solvent and transferred organic matter. This stage takes place in an extracting reactor 104.

In this case, the solvent is an ionic liquid with a melting point below 200° C., and the extraction reactor is configured to maintain the temperature between the ionic liquid's melting point and 200° C. In this case, the ionic liquid comprises one or more cations selected from the group consisting of: sulfonium, phosphonium, imidazolium, pyridinium, and ammonium and one or more anions selected from the group consisting of halogens, and organic anions containing at least one carboxylic group or at least one sulfonate group.

The solvent in this case also comprises a hydrogen donor or oxidant agent. These materials may help facilitate the direct conversion of kerogen in oil shale into a hydrocarbon that is soluble in the solvent. In addition, the hydrogen donor may facilitate removal of nitrogen and any remaining sulphur. Including Bronsted acids in the ionic liquid composition will mean that a hydrogen donor is included. This may be useful for upgrading reactions. Examples of such ionic liquids are [MimSO₃H]Cl, [HN₂₂₂][HSO₄], [C₂mim][HCl₂], [C₂mim][HSO₄]. About oxidants, addition of molecules such as hydrogen peroxide, iodine, hypochlorite, permanganate, TEMPO-type oxidants, phosphotungstic acid, palladium-, cobalt-, ruthenium-, or vanadium-complexes, polyoxometalate ions, and other known oxidants.

After the organic material has been transferred, the liquid phase comprises organic matter and ionic liquid. A solid phase now includes rock and any remaining organic matter which has not been transferred to the liquid phase.

The process then comprises separating the liquid phase from the solid phase. This separation takes place over a series of stages. Initially the large particulates are removed in a first separation stage 114. This leaves a substantially liquid phase with suspended finer particulates (e.g. comprising kerogen). The residue may then be disposed 115.

At the end of the process, the residue may comprise dry solids, with non-extracted kerogen (if any) and potentially some unrecovered ionic liquids.

A flocculation stage 105 is then used to cause these fine particulates to clump together in a floc. The floc may then float to the top of the liquid (creaming), settle to the bottom of the liquid (sedimentation), or be readily filtered from the liquid. A second solid/liquid separation 106 separates these organic particulates from the liquid phase. Not all the organic material may be dissolved. Some can be dissolved, some suspended, all dissolved, all suspended, etc. The addition of an anti-solvent to the ionic liquid-kerogen mixture induces the precipitation of any kerogen fraction that was dissolved. The kerogen then can be recovered using a solid/liquid separation technique.

The flocculation stage, in this case, comprises cooling the mixture to facilitate precipitation of the organic matter. Other embodiments may use anti-solvents.

Examples of regeneration can be removal of the anti solvent by vacuum distillation, nanofiltration, pervaporation, ion exchange, a combination of all, etc. This regeneration is configured to produce the ionic liquid solvent 111 which can be reused in the extraction reactor. The system may also comprise a heater to heat either the ionic liquid solvent and/or the extraction reactor. The system may comprise a heat exchange to reuse heat harvested from the flocculation stage.

The kerogen, in this case, is cracked 107 and upgraded 108 to make smaller-chain hydrocarbons which are suitable for producing useful products 109. It will be appreciated that the cracking and/or upgrading steps may occur offsite at another facility.

### In Situ Process

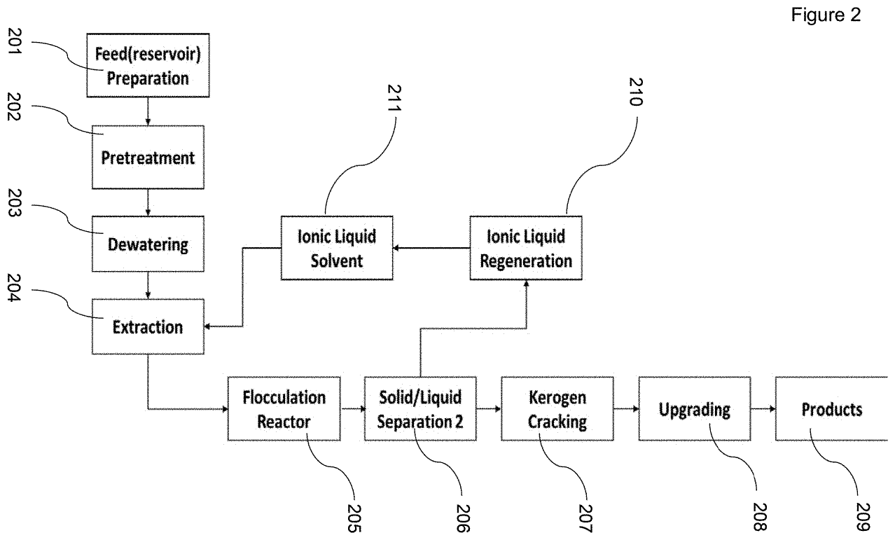

FIG. 2 is a flow chart for a downhole process for extracting organic matter insoluble in traditional solvents such as dichloromethane, toluene and hexane from solids (e.g. rock particles).

In this case, the solids are oil shale rocks containing kerogen organic matter. In contrast to the process of FIG. 1, in this case, the oil shale is not mined to bring the organic-matter-containing solids to the surface. The solids remain in place and the liquid treatments are injected downhole.

The reservoir is first prepared 201 by fracturing processes including, but not limited to, hydraulic fracturing, thermal fracturing, electro-static pulse fracturing, explosive fracturing, or combinations thereof.

In this case, the pre-treatment 202 includes an acid treatment in which acid is injected downhole and recycled to the surface. The acid treatment may help contribute to the partial removal of mineral in oil shale (e.g., HCl treatment can remove the calcite, the H₂SO₄ treatment can convert the calcite to CaSO₄, and the HF treatment can remove the quartz and convert the calcite to CaF₂) to facilitate the access of the ionic liquid to the organic matter.

After the pre-treatment stage, the solids are dried (dewatered 203). This may include direct drying techniques with hot gases.

After the solids have been dewatered, the process comprises combining organic-matter-containing solids and an ionic-liquid-enriched solvent comprising an ionic liquid such that the organic matter from the organic-matter-containing solids are transferred or extracted 204 into the ionic-liquid solvent to form a liquid phase comprising the ionic-liquid solvent and transferred organic matter. This stage takes place downhole by injecting the ionic liquid solvent. This ionic liquid solvent contacts the oil shale and the kerogen organic material is transferred to the solvent. The liquid can then be pumped to the surface. Because the solids are not crushed, the large particulates and fixed rocks remain downhole and are not extracted to the surface.

In this case, the solvent is an ionic liquid with a melting point below 200° C., and the extraction reactor is configured to maintain the temperature between the ionic liquid's melting point and 200° C. In this case, the ionic liquid comprises one or more cations selected from the group consisting of: sulfonium, phosphonium, imidazolium, pyridinium, and ammonium and one or more anions selected from the group consisting of halogens, and organic anions containing at least one carboxylic group or at least one sulfonate group.

The solvent in this case also comprises a hydrogen donor or oxidant agent. These materials may help facilitate the direct conversion of kerogen in oil shale into a hydrocarbon that is soluble in the solvent. In addition, the hydrogen donor may facilitate removal of nitrogen and any remaining sulphur. Including Bronsted acids in the ionic liquid composition will mean that a hydrogen donor is included. Examples of such ionic liquids are [MimSO₃H]Cl, [HN₂₂₂][HSO₄], [C₂mim][HCl₂], [C₂mim][HSO₄].

A flocculation stage 205 is used with the liquid extracted from the well to cause the fine kerogen particulates to clump together in a floc. The floc may then float to the top of the liquid (creaming), settle to the bottom of the liquid (sedimentation), or be readily filtered from the liquid. A solid/liquid separator 206 separates these organic particulates from the liquid phase.

The ionic liquid is then regenerated 210 using techniques such as vacuum distillation, crystallization, liquid-liquid extraction, supercritical CO₂, salting-out addition, adsorption columns, ion exchange columns, filtration or nanofiltration, pervaporation, decantation, centrifugation, use of magnetic films, membrane filtration, or a combination thereof, to produce the ionic liquid solvent 211 be reused downhole to transfer or extract the organic material.

The kerogen, in this case, is cracked 207 and upgraded 208 to make smaller-chain hydrocarbons which are suitable for producing useful products 209. It will be appreciated that this step may occur offsite at another facility.

### Experimental Results

These examples illustrate various aspects of the technology. Selected examples are illustrative of advantages that may be obtained compared to alternative separation processes, and these advantages are accordingly illustrative of particular embodiments and not necessarily indicative of the characteristics of all aspects of the technology.

The oil shales used in the examples are defined as “Stuart”, “Green River,” and “Jordan,” based on their source: Australia, Utah (USA), and Jordan. Their composition, determined by loss on ignition (LOI, a common and widely used method to estimate the moisture, organic, and ash content of sediments; ASTM D 7348-08), is reported on table 1 below.

TABLE 1

| Oil Shale | Moisture (%) | Ash (%) | Organic Content (%) |
|---|---|---|---|
| Stuart | 2.3 | 67.3 | 30.3 |
| Green River | 0.5 | 70.1 | 28.3 |
| Jordan | 0.5 | 76.0 | 23.5 |

Stuart oil shale mineralogical content of the shale is approximately 32% clays (kaolinite and smectite), 20% quartz (SiO₂), 3% siderite (FeCO₃), pyrite (FeS₂), and highly variable amounts of CaCO₃ (up to 15%) (Patterson, J. H.; Henstridge, D. A. Chem. Geol. 1990, 82, 319-339).

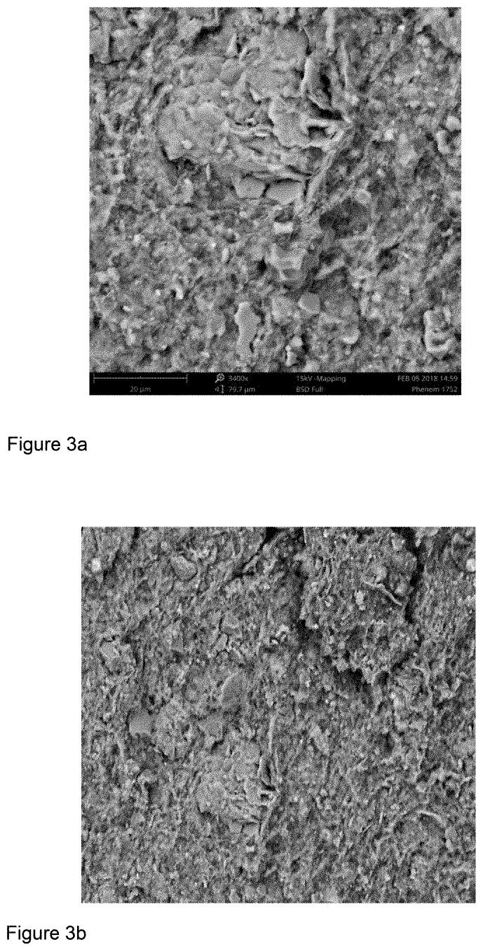

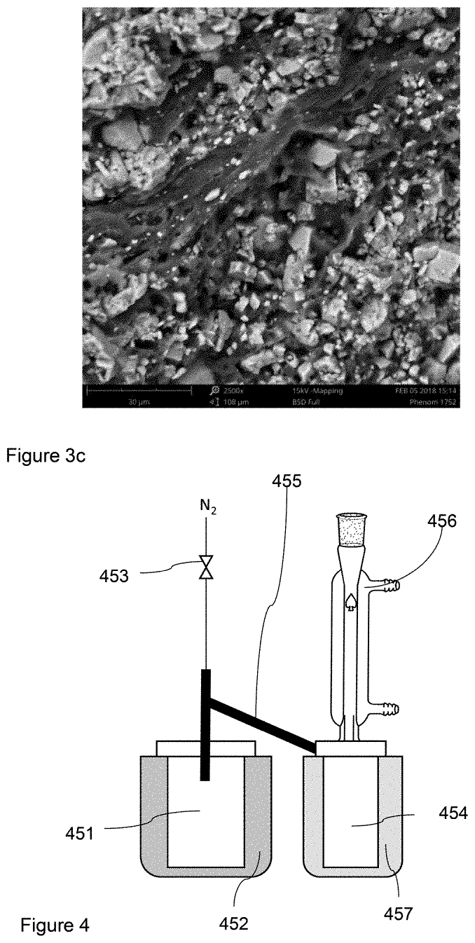

An initial microscopic examination was performed on a roughly 2 cm×2 cm piece of Stuart oil shale, split along its bedding plane and scanned by scanning electron microscope (SEM) (FIGS. 3a and 3b). Immediately apparent was filamentous organic matter intertwined throughout the mineral matrix. An energy dispersive x-ray (EDX) was pointed at the filaments and indicated their composition to be primarily carbon and oxygen, the source of kerogen in the Stuart oil shale.

A close examination of the filaments in both micrographs suggests that the filaments form an organic matrix, within which mineral particulate is embedded. It is further suggested that removal and mobilization of the organic filaments by an ionic liquid result in the release of mineral particulate from matrix and accounts for the fine mineral particulate that was observed in precipitated pellets of kerogen produced in the first series of extraction experiments.

In support of these observations an additional micrograph was obtained on a fresh surface of un-extracted Green River oil shale (Utah). The Green River oil shale has a similar depositional history and age (54 my) as the Stuart shale. FIG. 3c shows a filamentous mat in cross section, imbedded with mineral particles. As with the Stuart shale, the EDX indicated that the mat was predominantly carbon with some oxygen. The mat can clearly be observed as the host matrix with the mineral imbedded in its structure.

In the next series of examples that follow, the ionic liquids were either synthesized or purchased as described below.

The Ionic Liquids trihexyltetradecylphosphonium bis(trifluoromethylsulfonyl)amide ([P₆₆₆₁₄][NTf₂]) and 1-ethyl-3-methylimidazolium acetate ([C₂mim][OAc]) were purchased from loLiTec™ (Tuscaloosa, Ala., USA).

Synthesis of octylammonium oleate ([C₈NH₃][Oleate]), tributylammonium oleate ([HN₄₄₄][Oleate]), N-octylammonium dodecylbenzenesulfonate ([C₈NH₃][C₁₂BenzSO₄]), and triethylammonium oleate ([HN₂₂₂][Oleate]): These were synthesized and purified as previously reported by McCrary et al. (2013). N-octylamine, tributylamine, triethylamine, oleic acid, and dodecylbenzenesulfonic acid were purchased from Sigma-Aldrich™ (St. Louis, Mo., USA) and used as received. The amine (10 mmol) was placed in a 500 mL two-neck round bottom flask cooled using an ice water bath to 0° C. while stirring vigorously using a magnetic stir bar. A condenser was placed on the top of the round bottom flask. The second end of the neck was covered using a rubber stopper. The acid (oleic acid or dodecylbenzenesulfonic acid, 10 mmol) was added drop-wise while maintaining the temperature at 0° C. Each reaction was immediately exothermic and turned a light-yellow shade upon finishing the addition. The reactions were stirred overnight remaining in the water bath, but the temperature was allowed to slowly rise to ambient conditions. ¹H-NMR (360 MHz, DMSO-d6) was used to confirm the product and purity.

Synthesis of hydroxylammonium acetate ([NH₃OH][OAc]): It was synthesized by acid-based neutralization, following the protocol previously reported by Griggs et al.

Synthesis of Brønsted acidic —SO₃H Ionic Liquid [MimSO₃H]Cl: 250 mL round bottom flask equipped with Teflon coated magnetic stir bar was loaded with 1-methylimidazole (Mim) (50 mmol) in dichloromethane (100 mL) followed by very slow addition of chlorosulfonic acid (ClSO₃H) (60 mmol). While adding ClSO₃H an exothermic reaction takes place. The mixture was stirred for 12 h at room temperature. After 12 h, the solvent was evaporated under rotavapor and a brown free-flowing liquid was obtained.

Synthesis of Brønsted acidic Ionic Liquid [HN₂₂₂][HSO₄]: 250 mL round bottom flask equipped with Teflon coated magnetic stir bar was loaded with triethylamine (25 mmol) in dichloromethane (50 mL) followed by very slow addition of sulfuric acid (25 mmol). After addition, exothermic reaction was observed and stirred another 12 h at room temperature. After 12 h, the solvent was evaporated under rotavapor and a colorless solid was obtained.

Synthesis of Brønsted acidic Ionic Liquid [C₂mim][HCl₂]: 250 mL round bottom flask equipped with Teflon coated magnetic stir bar was loaded with [C₂mim]Cl (25 mmol) followed by very slow addition of hydrochloric acid (25 mmol) in isopropanol (50 mL). After addition, exothermic reaction was observed and stirred overnight at 35° C. After reaction time, the solvent was evaporated under rotavapor and finally dried under high vacuum at 70° C.

Synthesis of Lewis acidic Ionic Liquid [HN₂₂₂][Al₂Cl₇]: In an Ar-filled glove bag, 50 mL borosilicate glass screw-top vial equipped with a Teflon coated magnetic stir bar was loaded with white crystalline [HN₂₂₂]Cl (30 mmol) followed by portion wise addition of white solid AlCl₃ (60 mmol). While adding AlCl₃ an exothermic reaction takes place to form gray liquid Ionic Liquid at room temperature. After addition, the vial was covered with a cap, and sealed with Parafilm. The vial was then removed from the glove bag and heated with magnetic stirring in a temperature-controlled oil bath at 60° C. After 4 h, the vial was removed from the oil bath and left to cool on the bench top. A grey liquid was obtained.

In the following examples, the “solvent insoluble fraction” recovered from oil shale using ionic liquids and the oil shales themselves were characterized using the following techniques:

A loss on ignition protocol for quantification of organic mass in the recovered precipitate and in the oil shale before and after extraction (ASTM D 7348-08).

Pyrolysis of the recovered material in a modified Fischer Assay (MFA) setup, followed by the injection of the mixture into a Gas Chromatograph-Mass Spectrometer (GC-MS) to confirm that the produced oil is a petroleum product similar in molecular distribution to crude oil.

The dry composite solids resembling a brown filter cake were mixed with quartz sand in a glass retort. Using the Modified Fischer Assay Apparatus shown in FIG. 4, the mixture was added to a flask 451, which was placed onto a heating mantle 452 (as shown in FIG. 4). The heating mantle was used at full power and was rated for a temperature of 450° C. The retort was covered with a ceramic cover.

The solid mixture was heated under a constant N₂ blanket pumped into the flask via flow meter 453. Vapour from the flask passed into a collector 454 via a heated line 455. The collector was cooled by an ice bath 457 and was positioned below a condenser 456. Vapor and then condensed liquids were observed in the collector as the retort heated up. Clear liquids were observed refluxing inside the glass retort during heating. The MFA powered down and allowed to cool to ambient temperature under N₂ blanket.

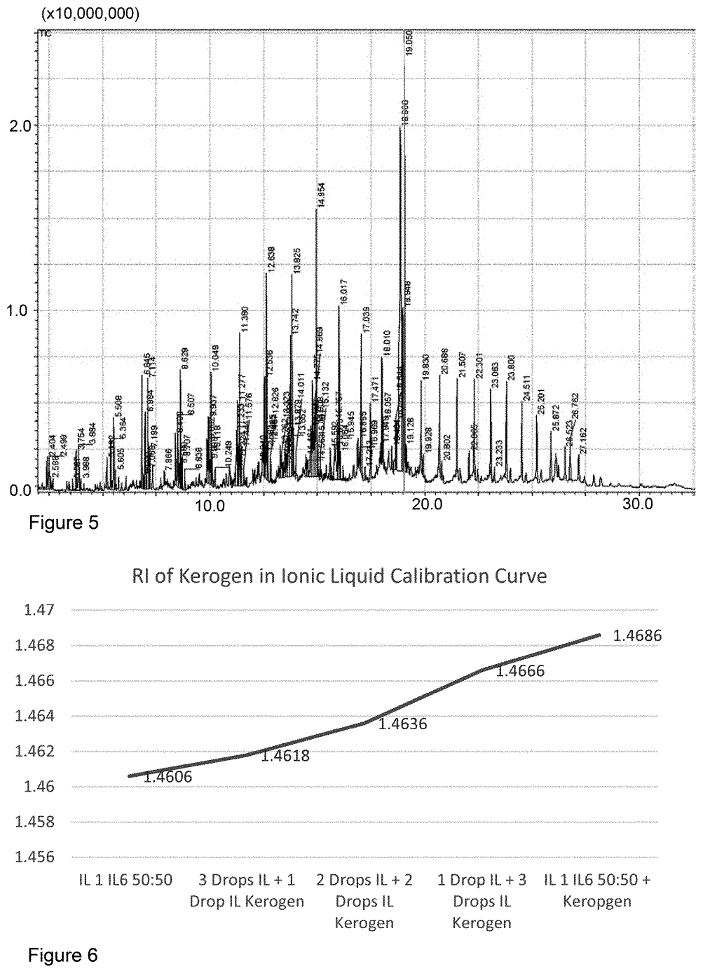

Aliquots of the produced oil from the retort and the receiver were analyzed using a Shimadzu QP2010SE gas chromatogram-mass spectrometer (GC-MS). The 2014 NIST spectral library was used to identify the detected compounds. An example GC-MS total ion chromatograph is shown in FIG. 5. Each peak corresponds to a different compound.

### Quantification of Organic Material in Organic Material/Ionic Liquids Mixture

Besides pyrolysis, several techniques were developed to quantify the organic material present in the organic material/ionic liquid mixture. In all the techniques described below, different amounts of extracted organic material were re-dissolved in a specific ionic liquid to generate solutions of known concentration and generate a calibration curve. The concentration of organic matter present in the organic material/ionic liquid mixture may be quantified using techniques such as density, viscosity, dynamic light scattering, refractive index, or a combination thereof.

The Refractive index is the ratio of the velocity of light in a vacuum to its velocity in a specified medium. It was hypothesized that dissolved kerogen would change the refractive index of specific ionic liquids. To demonstrate such hypothesis, the octylammonium oleate and tributylammonium oleate mixture was used as “ionic liquid solvent” and a sample of kerogen was added to the ionic liquid solvent. The refractive index proportionally increases with the increase in the amount of organic material (FIG. 6).

### Laboratory Scale Static Batch Extraction Examples

A series of in batch extraction tests were performed. Different families of ionic liquids, extraction temperatures, contact time, and shale particle sizes were evaluated. In general, the ionic liquid solvent was mixed with the oil shale and heated, with occasional manual stirring. The samples were then centrifuged and the organic material/ionic liquid extract was decanted off into a second vial for precipitation. Fresh ionic liquid solvent was then added to the shale and repeat the extraction until no further discoloration of the ionic liquid solvent was observed. The kerogen dissolved in the ionic liquids was precipitated with methanol and centrifuged to a pellet, dried and weighed.

### Example 1

Ten grams of pre-crushed Stuart oil shale and 30 mL octylammonium oleate ([C₈NH₃][Oleate]) were placed in a 50 mL digestion tube and stirred using a glass rod to completely wet the shale with [C₈NH₃][Oleate]. The mixture was heated to 95° C. for 2 h in a temperature-controlled digester and manually stirred frequently. The light amber [C₈NH₃][Oleate] changed color to black almost immediately on stirring. The sample was cooled after 2 h and left at room temperature for 48 h. After 48 h at ambient temperature, the tube containing the mixture was centrifuged at 750 rpm for 10 min. A dark amber colored liquid (20 mL) was decanted off into a clean high-speed centrifuge tube and centrifuged at 7000 rpm for 5 min. No precipitate was observed. An equal volume (20 mL) of methanol was then added to the [C₈NH₃][Oleate]/kerogen solution, shaken and spun at 7000 rpm for another 5 min, obtaining a precipitate (methanol insoluble fraction, MIF). Further additions of the [C₈NH₃][Oleate]/kerogen/methanol solution were added to the same centrifuge tube to build up a large pellet. It was observed that the material is insoluble in different solvents (pentane, hexane, dichloromethane, carbon disulfide, methanol, ethanol, and toluene). A small sample of the precipitate was burned. The odor of combustion indicated possible presence of kerogen (a distinctive, peaty odor). The discoloration of the ionic liquid solvent, together with the odor of combustion from the recovered solid indicates the recovery of organic matter, which was insoluble in traditional solvents, i.e., of kerogen.

### Example 2

Three 20 grams samples of crushed Stuart Oil shale (Australia) and 30 mL octylammonium oleate ([C₈NH₃][Oleate]) were placed in 50 mL centrifugation tubes and stirred using a glass rod to completely wet the shale with [C₈NH₃][Oleate]. The mixtures were heated at 100° C. for 8 h with occasional stirring. All the samples were initially centrifuged at 850 rpm for 15 min in the tubes. The free black liquid obtained from the three 100° C. stirred samples were observed to be very viscous. Free liquid (˜8 mL) from all three of these samples was slowly decanted off of the solids layer and combined into one 50 mL centrifuge tube producing approximately 25 mL of recovered [C₈NH₃][Oleate]-rich phase. After methanol addition (25 mL) and centrifugation, significant precipitate was observed. The alcohol/[C₈NH₃][Oleate] supernatant was still black and was divided equally between two more 50 mL centrifuge tubes, diluted with equal volumes of methanol and re-spun at 3500 rpm for 15 min producing another small amount of precipitate. Successive extractions of the oil shale were performed using fresh [C₈NH₃][Oleate] each time, until the [C₈NH₃][Oleate] was not discolored. When the fifth batch (30 mL) of [C₈NH₃][Oleate] was added and extraction was attempt, no discoloration of the Ionic Liquid was observed. The precipitate obtained in the extractions was dried overnight (105° C. in an oven). The resulting (total) solid was 4.82 g, with variations in the organic contents (determined using loss on ignition test, Table 2 below), which represents an extraction of 33.8% of the total organics present in the total shale.

TABLE 2

| Extraction # | MIF (g) | Organic Content (%) | Extracted Organics (g) |
|---|---|---|---|
| 1 | 1.28 | 33.8 | 0.43 |
| 2 | 1.53 | 44.0 | 0.67 |
| 3 | 1.21 | 51.5 | 0.62 |
| 4 | 0.8 | 35.6 | 0.28 |
| Total | 4.82 | | 2.00 |

(MIF: Methanol insoluble fraction)

### Example 3

Twenty (20) grams of pre-crushed Stuart Oil shale (Australia) and 30 mL trihexyltetradecylphosphonium bis(trifluoromethylsulfonyl)imide ([P₆₆₆₁₄][NTf₂]) were placed in 50 mL centrifugation tubes and stirred using a glass rod to completely wet the shale with [P₆₆₆₁₄][NTf₂]. The mixture was heated at 100° C. for 6 h with occasional (hourly) stirring. After 6 h, the tube was centrifuged at 4000 rpm for 30 min. After centrifugation, the upper phase was observed to remain with the same color of the original [P₆₆₆₁₄][NTf₂]. Since no discoloration of [P₆₆₆₁₄][NTf₂] was observed, the extraction process was not continued. Under these experimental conditions, the extraction of kerogen using [P₆₆₆₁₄][NTf₂] was considered to be negligible. The negligible (to none) hydrogen-bond capacity of the anion in this ionic liquid may limit the performance of this ionic liquid.

### Example 4

Twenty (20) grams of pre-crushed Stuart Oil shale (Australia) and 30 mL triethylammonium oleate ([HN₂₂₂][Oleate]) were placed in a 50 mL centrifugation tube and stirred using a glass rod to completely wet the shale with [HN₂₂₂][Oleate]. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of precipitate was observed. The alcohol/[HN₂₂₂][Oleate] was decanted into a bottle for further processing. When the second batch (30 mL) of [HN₂₂₂][Oleate] was added and extraction was attempt, no discoloration of the Ionic Liquid was observed. The precipitate obtained in the first extraction was dried overnight (105° C. in an oven). After washings and drying, the resulting solid was 0.70 g, 75.4 wt % of which were organics (determined using loss on ignition test), which represents an extraction of 8.9% of the total organics present in the sample.

### Example 5

Twenty (20) grams of pre-crushed Green River oil shale and 30 mL triethylammonium oleate ([HN₂₂₂][Oleate]) were placed in a 50 mL centrifugation tube and stirred using a glass rod to completely wet the shale with [HN₂₂₂][Oleate]. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of precipitate was observed. The alcohol/[HN₂₂₂][Oleate] was decanted into a bottle for further processing. Successive extractions of the oil shale were performed using fresh [HN₂₂₂][Oleate] each time, until the Ionic Liquid was not discolored. When the fourth batch (30 mL) of [HN₂₂₂][Oleate] was added and extraction was attempt, no discoloration of the Ionic Liquid was observed. The obtained precipitates were washed with methanol, dried overnight (105° C. in an oven), and, due to the low amounts recovered, were combined before loss on ignition characterization. After washings and drying, the resulting solid was 0.87 g, 97.8 wt % of which were organics (determined using loss on ignition test), which represents an extraction of 15.0% of the total organics present in the sample.

| Extraction # | MIF (g) | Organic Content (%) | Extracted Organics (g) |
|---|---|---|---|
| 1 | 0.35 | N/A | N/A |
| 2 | 0.32 | N/A | N/A |
| 3 | 0.20 | N/A | N/A |
| Total | 0.87 | 97.8 | 0.85 |

(MIF: Methanol insoluble fraction)

### Example 6

Twenty (20) grams of pre-crushed Stuart Oil shale (Australia) and 30 mL N-octylammonium dodecylbenzenesulfonate ([C₈NH₃][C₁₂BenzSO₄]) were placed in a 50 mL centrifugation tube and stirred using a glass rod to completely wet the shale with [C₈NH₃][C₁₂BenzSO₃]. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of MIF precipitate was observed. The alcohol/[C₈NH₃][C₁₂BenzSO₄] was decanted into a bottle for further processing. Successive extractions of the oil shale were performed using fresh liquid salt each time, until the Ionic Liquid was not discolored. When the third batch (30 mL) of [C₈NH₃][C₁₂BenzSO₃] was added and extraction was attempt, no discoloration of the Ionic Liquid was observed. The MIF obtained in the extractions were dried overnight (105° C. in an oven). After washings and drying, the resulting (total) solid was 2.18 g, with variations in the organic contents (determined using loss on ignition test, Table 3 below), which represents an extraction of 18.1% of the total organics present in the total shale.

TABLE 3

| Extraction # | MIF (g) | Organic Content (%) | Extracted Organics (g) |
|---|---|---|---|
| 1 | 1.09 | 57.9 | 0.63 |
| 2 | 1.09 | 40.5 | 0.44 |
| Total | 2.18 | | 1.07 |

(MIF: Methanol insoluble fraction)

### Example 7

Twenty (20) grams of pre-crushed Green River oil shale and 30 mL tributylammonium oleate ([HN₄₄₄][Oleate]) were placed in a 50 mL centrifugation tube and stirred using a glass rod to completely wet the shale with [HN₄₄₄][Oleate]. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of MIF precipitate was observed. The alcohol/[HN₄₄₄][Oleate] was decanted into a bottle for further processing. Successive extractions of the oil shale were performed using fresh [HN₄₄₄][Oleate] each time, until the liquid salt was not discolored. When the fourth batch (30 mL) of [HN₄₄₄][Oleate] was added and extraction was attempt, no discoloration of the Ionic Liquid was observed. The obtained MIFs were washed with methanol, dried overnight (105° C. in an oven), and, due to the low amounts recovered, were combined before loss on ignition characterization. After washings and drying, the resulting solid was 0.62 g, 82.1 wt % of which were organics (determined using loss on ignition test), which represents an extraction of 9.0% of the total organics present in the sample.

TABLE 4

| Extraction # | MIF (g) | Organic Content (%) | Extracted Organics (g) |
|---|---|---|---|
| 1 | 0.41 | N/A | N/A |
| 2 | 0.14 | N/A | N/A |
| 3 | 0.07 | N/A | N/A |
| Total | 0.62 | 82.1 | 0.509 |

(MIF: Methanol insoluble fraction)

### Example 8

Twenty (20) grams of pre-crushed Green River oil shale and 30 mL trioctylammonium oleate ([HN₈₈₈][Oleate]) were placed in a 50 mL centrifugation tube and stirred using a glass rod to completely wet the shale with [HN₈₈₈][Oleate]. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of precipitate was observed. The alcohol/[HN₈₈₈][Oleate] was decanted into a bottle for further processing. Successive extractions of the oil shale were performed using fresh [HN₈₈₈][Oleate] each time, until the liquid salt was not discolored. When the fourth batch (30 mL) of [HN₈₈₈][Oleate] was added and extraction was attempt, no discoloration of the Ionic Liquid was observed. The obtained precipitates were washed with methanol, dried overnight (105° C. in an oven), and, due to the low amounts recovered, were combined before loss on ignition characterization. After washings and drying, the resulting solid was 0.56 g, 92.2 wt % of which were organics (determined using loss on ignition test), which represents an extraction of 9.2% of the total organics present in the sample.

TABLE 5

| Extraction # | MIF (g) | Organic Content (%) | Extracted Organics (g) |
|---|---|---|---|
| 1 | 0.09 | N/A | N/A |
| 2 | 0.25 | N/A | N/A |
| 3 | 0.22 | N/A | N/A |
| Total | 0.56 | 92.2 | 0.52 |

(MIF: Methanol insoluble fraction)

### Example 9

Twenty (20) grams of pre-crushed Green River oil shale and 30 mL of a mixture of [C₈NH₄][Oleate] and [HN₄₄₄][Oleate] mixed at different ratios (50:50 or 75:25) were placed in a 50 ml centrifugation tube and stirred using a glass rod to completely wet the shale. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of precipitate was observed. The alcohol/Ionic Liquid was decanted into a bottle for further processing. Successive extractions (three total) of the oil shale were performed using fresh Ionic Liquid each time. The obtained MIFs were washed with methanol, dried overnight (105° C. in an oven), and, due to the low amounts recovered, were combined before loss on ignition characterization.

Using Green River oil shale and 50:50 [C₈NH₄][Oleate]:[HN₄₄₄][Oleate], the precipitates obtained after first, second, and third extractions were 0.09, 0.07, and 0.06 g, respectively. Due to the total precipitate obtained (0.22 g), the loss on ignition was not determined.

Using Green River oil shale and 75:25 [C₈NH₄][Oleate]:[HN₄₄₄][Oleate], the precipitates obtained after first, second, and third extractions were 0.06, 0.05, and 0.08 g, respectively. Due to the total MIF obtained (0.19 g), the loss on ignition was not determined.

Using Stuart oil shale and 50:50 [C₈NH₄][Oleate]:[HN₄₄₄][Oleate], the resulting solid was 0.96 g, 89.0 wt % of which were organics (determined using loss on ignition test), which represents an extraction of 14.0% of the total organics present in the sample.

TABLE 6

| Extraction # | MIF (g) | Organic Content (%) | Extracted Organics (g) |
|---|---|---|---|
| 1 | 0.14 | N/A | N/A |
| 2 | 0.24 | N/A | N/A |
| 3 | 0.58 | N/A | N/A |
| Total | 0.96 | 89.0 | 0.85 |

(MIF: Methanol insoluble fraction)

### Example 10

Twenty (20) grams of pre-crushed Stuart Oil shale (Australia) and 30 mL of ethanolammonium oleate were placed in a 50 mL centrifugation tube and stirred using a glass rod to completely wet the shale with the liquid salt. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of precipitate was observed. The alcohol/Ionic Liquid was decanted into a bottle for further processing. Successive extractions of the oil shale were performed using fresh ethanolammonium oleate each time, until the Ionic Liquid was not discolored. When the fourth batch (30 mL) of ethanolammonium oleate was added and extraction was attempt, no discoloration of the Ionic Liquid was observed. The obtained precipitates were dried overnight (105° C. in an oven). After washings and drying, the resulting (total) solid was 2.052 g, with variations in the organic contents (determined using loss on ignition test, Table 7 below), which represents an extraction of 17.1% of the total organics present in the total shale.

TABLE 7

| Extraction # | MIF (g) | Organic Content (%) | Extracted Organics (g) |
|---|---|---|---|
| 1 | 0.505 | 68.2 | 0.34 |
| 2 | 0.597 | 55.8 | 0.33 |
| 3 | 0.950 | 35.9 | 0.34 |
| Total | 2.052 | | 1.01 |

(MIF: Methanol insoluble fraction)

### Example 11

Twenty (20) grams of pre-crushed Stuart Oil shale (Australia) and 30 mL of a 50 wt % [NH₃OH][OAc] aqueous solution were placed in a 50 mL centrifugation tube and stirred using a glass rod to completely wet the shale. The mixture was heated at 100° C. for 6 h with occasional stirring. After 6 h, the tube was centrifuged at 4000 rpm for 30 min. After centrifugation, the black upper phase was transferred into a second centrifugation tube and methanol was added in a 1:1 solvent:Ionic Liquid/kerogen ratio, vortex it for 1 min, and centrifuged at 4000 rpm for 5 min. After methanol addition and centrifugation, significant amount of precipitate was observed. The alcohol/Ionic Liquid was decanted into a bottle for further processing. Successive extractions of the oil shale were performed using fresh [NH₃OH][OAc] each time, until the liquid salt was not discolored. Discoloration of the Ionic Liquid indicated extraction of the organic fraction of the kerogen.

### Example 12

Twenty (20) grams of pre-crushed Stuart Oil shale (Australia) and 30 mL 1-ethyl-3-methylimidazolium acetate ([C₂mim][OAc]) were placed in a 50 mL centrifugation tube and stirred using a glass rod to completely wet the shale with [C₂mim][OAc]. The mixture was heated at 100° C. for 6 h with occasional stirring. After 6 h, the tube was centrifuged at 4000 rpm for 30 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of precipitate was observed. The alcohol/Ionic Liquid was decanted into a bottle for further processing. Successive extractions of the oil shale were performed using fresh [C₂mim][OAc] each time, until the Ionic Liquid was not discolored. When the fourth batch (30 mL) of [C₂mim][OAc] was added and extraction was attempt, no discoloration of the Ionic Liquid was observed. The precipitates obtained in the extractions were dried overnight (105° C. in an oven). After washings and drying, the resulting (total) solid was 1.775 g, with variations in the organic contents (determined using loss on ignition test, Table 8 below), which represents an extraction of 14.7% of the total organics present in the total shale.

TABLE 8

| Extraction # | MIF (g) | Organic Content (%) | Extracted Organics (g) |
|---|---|---|---|
| 1 | 0.580 | 54.2 | 0.31 |
| 2 | 0.720 | 48.8 | 0.35 |
| 3 | 0.475 | 43.7 | 0.21 |
| Total | 1.775 | | 0.87 |

(MIF: Methanol insoluble fraction)

### Example 13

Twenty (20) grams of pre-crushed Stuart Oil shale (Australia) and 30 mL oleic acid (commercially available) were placed in a 50 mL centrifugation tube and stirred using a glass rod to completely wet the shale with the fatty acid. The mixture was heated at 100° C. for 6 h with occasional stirring. After 6 h, the tube was centrifuged at 4000 rpm for 30 min. After centrifugation, the upper phase was observed to remain with the same color of the original oleic acid. Since no discoloration of the upper phase was observed, the extraction process was not continued. Under these experimental conditions, the extraction of kerogen using oleic acid was considered to be negligible.

### Example 14

Twenty (20) grams of pre-crushed Stuart Oil shale (Australia) and 30 mL of ionic liquid solvent ([C₈NH₃][Oleate], [C₈NH₃][C₁₂BenzSO₃], [C₂mim][OAc], or [HN₂₂₂][Oleate]) were placed in a 50 mL centrifugation tube and stirred using a glass rod to completely wet the shale with the ionic liquid solvent. The mixture was heated at 100° C. for 6 h with occasional stirring. After 6 h, the tube was centrifuged at 4000 rpm for 30 min and the upper phase was transferred into a bottle for further processing. Successive washings of the oil shale were performed using 15 mL of fresh ionic liquid solvent but the oil shale/Ionic Liquid mixture was not exposed to high temperatures, until the Ionic Liquid was not discolored. The precipitates obtained in the extractions were dried overnight (105° C. in an oven). After washings and drying, the resulting (total) solid varied depending on the ionic liquid used (percentages based on total organic content of the oil shale): 27% using [C₈NH₃][Oleate], 16.2% using [C₈NH₃][C₁₂BenzSO₃], 13.5% [C₂mim][OAc], and 15.5% using [HN₂₂₂][Oleate].

### Example 15

Twenty (20) grams of pre-crushed Stuart Oil shale (Australia) and 20 mL hydrochloric acid (1M) were placed in a 50 mL centrifugation tube and left overnight at room temperature. After reaction time, the solids were washed with DI water several times, until pH of the water was neutral. The solids were left overnight in the oven at 100° C. for drying.

Thirty (30) mL of [C₈NH₃][Oleate] were added to the dried solids and the mixture was heated at 100° C. for 6 h with occasional stirring. After 6 h, the tube was centrifuged at 4000 rpm for 15 min. After centrifugation, the black upper phase was transferred into a second centrifugation tube and 15 mL methanol was added, vortex it for 1 min, and centrifuged at 4000 rpm for 5 min. After methanol addition and centrifugation, significant amount of MIF precipitate was observed. The alcohol/Ionic Liquid was decanted into a bottle for further processing. Successive extractions of the oil shale were performed using fresh [C₈NH₃][Oleate] each time, until the Ionic Liquid was not discolored. When the fourth batch (30 mL) of [C₈NH₃][Oleate] was added and extraction was attempt, no discoloration of the Ionic Liquid was observed. The precipitates obtained in the extractions were dried overnight (105° C. in an oven). After washings and drying, the resulting (total) solid was 3.1 g, with variations in the organic contents (determined using loss on ignition test, Table 9 below), which represents an extraction of 41.3% of the total organics present in the total shale.

TABLE 9

| Extraction # | MIF (g) | Organic Content (%) | Extracted Organics (g) |
|---|---|---|---|
| 1 | 0.74 | 83.5 | 0.62 |
| 2 | 0.58 | 81.4 | 0.47 |
| 3 | 1.78 | 84.0 | 1.49 |
| Total | 3.1 | | 2.58 |

(MIF: Methanol insoluble fraction)

### Example 16

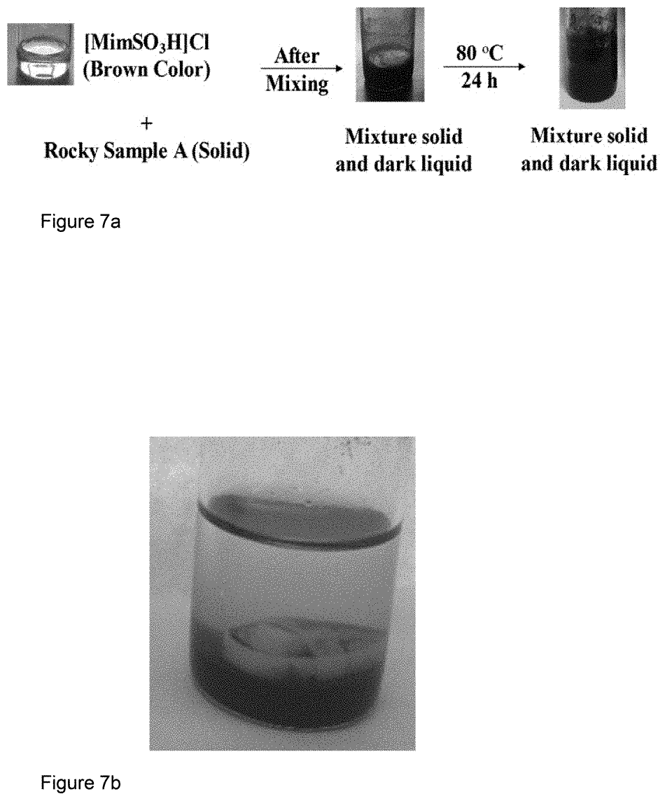

Pre-crushed Stuart oil shale was mixed in a 20 mL glass vial containing a magnetic stirrer with the Brønsted acidic [Mim-SO₃H]Cl Ionic Liquid in a 1:10 ratio by weight. The mixture was stirred in a temperature-controlled oil bath at 80° C. for 24 h. After reaction time, a mixture of dark liquid and solids was observed, in which is different than Ionic Liquid color, indicating reaction with the organic matter contained in the oil shale (FIG. 7a). The reaction mixture was centrifuged, separating the dark liquid from the solid phase. As control, the oil shale was mixed with toluene in a 1:10 ratio by weight and stirred in a temperature-controlled oil bath at 80° C. for 24 h. No change in color was observed in upper toluene layer (FIG. 7b). This indicates that the organic material is insoluble in the conventional solvent toluene.

The upper, liquid phase was washed with toluene 5 times. The toluene phase was analyzed by GC-MS. Besides peaks related with toluene, other peaks were identified, indicating organics extraction in the solvent phase. The remaining toluene phase was collected and the solvent (toluene) was evaporated using rotavapor. A grey solid was obtained.

When the toluene obtained from the control experiment (using toluene as solvent instead of [Mim-SO₃H]Cl) was injected in the GC-MS, no extra peaks other than toluene were detected.

### Example 17

Pre-crushed Stuart oil shale (or Jordanian oil shale) was mixed in a 22 mL glass vial containing a magnetic stir bar with the acidic [C₂mim][HCl₂] Ionic Liquid in a 1:10 ratio by weight. The mixture was stirred in a temperature-controlled oil bath at 110° C. for 24 h. After reaction time, a mixture of dark liquid and solids was observed, different than original Ionic Liquid color, indicating extraction of the organic matter contained in the oil shale. The reaction mixture was centrifuged, separating the dark liquid from the solid phase. The upper, liquid phase was decanted to a centrifugation tube and water was added, resulting in precipitation after centrifugation. The residue left in the glass vial (shales) was washed with water and dried overnight. The extracted mass (calculated as the difference between the original weight of the sample and the residue) was 46.7 and 67.7 wt % for Stuart and Jordanian oil shale, respectively.

### Example 18

Ten (10)-mL borosilicate glass screw-top vials equipped with Teflon coated magnetic stir bars were loaded with oil shale (0.2 g) followed by addition of Ionic Liquid (Ionic Liquid: [C₂mim][OAc], [C₂mim][HSO₄], [HN₂₂₂][HSO₄], [MimSO₃H]Cl) (2 g) with 1:10 weight ratio. After addition, the vials were covered with a cap, and sealed with Parafilm. The vials were then heated in a temperature-controlled oil bath with magnetic stirring at 80° C. After 24 h the vials were removed from the oil bath and left to cool on the bench top and recorded observations. Later, the reaction mixtures were centrifuged and separated liquid from solid. A dark liquid observed after centrifugation indicates extraction of organic matter.

| | Physical Observations | | | |
|---|---|---|---|---|
| | | After | | |
| | After | Reaction at | After Reaction at | After |
| Ionic Liquid/Oil Shale | Mixing | 80° C. | 27° C. | Centrifugation |
| [C₂mim][OAc]/Stuart | Mixture of | Solid | Solid suspended | Solid separated |
| [C₂mim][OAc]/Jordanian | solid and | suspended | in dark liquid | from liquid |

| | | | |
|---|---|---|---|
| [C₂mim][HSO₄]/Stuart | liquid | in dark | Dark viscous (visual observation) |
| [C₂mim][HSO₄]/Jordanian | | liquid | (Under polarizing microscope, solid |
| | | | suspended in liquid) |
| [HN₂₂₂][HSO₄]/Stuart | Mixture of | | Dark solid (visual observation) (But |
| | two solids | | under polarizing microscope, mixture |
| | | | of two solids) |

| | | | |
|---|---|---|---|
| [MimSO₃H]Cl/Stuart | Example 15 | Solid suspended | Solid separated |
| | | in dark liquid | from liquid |

### Example 19

In an Ar-filled glove bag, 10-mL borosilicate glass screw-top vial equipped with Teflon coated magnetic stir bar was loaded with oil shale (0.2 g) followed by addition of [HN₂₂₂][Al₂Cl₇] (2 g) with 1:10 wt ratio. After addition, the vial was covered with a cap, and sealed with Parafilm. The vial was then removed from the glove bag and heated with magnetic stirring in a temperature-controlled oil bath at 80° C. After 24 h, the vial was removed from the oil bath and left to cool on the bench top and obtained mixture of dark liquid and solid. A dark liquid observed after centrifugation indicates extraction of organic matter.

| | Physical Observations | | | |
|---|---|---|---|---|
| | | After | | |
| Ionic Liquid/Oil | After | Reaction at | After Reaction | After |
| Shale | Mixing | 80° C. | at 27° C. | Centrifugation |

| | | | |
|---|---|---|---|
| [HN₂₂₂][Al₂Cl₇]/ | Mixture of | Solid | Dark viscous |
| Stuart | solid and | suspended in | (visual observation) |
| | liquid | dark liquid | (Under polarizing microscope, |
| | | | solid suspended in liquid) |

### Example 20

Ten (10)-mL borosilicate glass screw-top vials equipped with Teflon coated magnetic stir bars were loaded with 0.1 g Stuart (or Jordanian) oil shale and 5 g Ionic Liquid [C₂mim][OAc] (2 wt % sample). After addition, the vial was heated using microwave for 2 min, with 3 sec pulses and stirring by hand between pulses. After reaction, the mixture was left to cool down to room temperature and was centrifuged to separate any unreacted/undissolved solid. The residue and the supernatant were separated. The residue left in the glass vial (shales) was washed with water and dried overnight. The extracted mass (calculated as the difference between the original weight of the sample and the residue) was 24.4 and 37.5 wt % for Stuart and Jordanian oil shales, respectively.

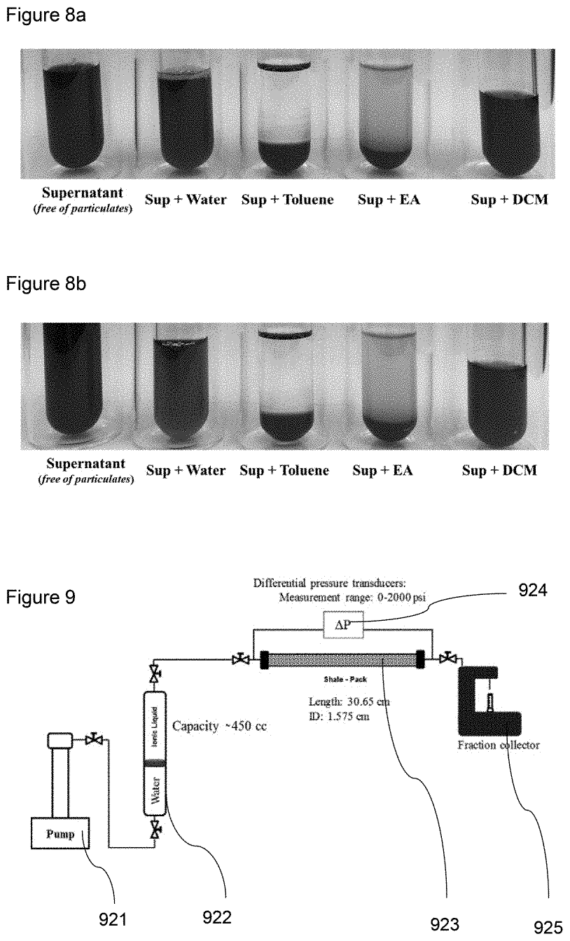

Aliquots of the supernatant (0.5 g) were placed in glass tubes and 3 g of solvent (water, toluene, ethyl acetate, and dichloromethane) were added (FIGS. 8a-b). The mixture was vortex for 15 s and centrifuged. For both samples (either Stuart or Jordanian oil shale), precipitates were observed using water, while two phases were observed using toluene or ethyl acetate (FIGS. 8a-b). This indicates that the supernatant was not soluble in these materials. GC-MS of toluene and EA layers indicated presence of methylimidazole and ethylimidazole after microwave irradiation.

### Example 21

Ten (10)-mL borosilicate glass screw-top vials equipped with Teflon coated magnetic stir bars were loaded with oil shale (0.1 g) and excess of benzene solvent (2 mL) followed by addition of Ionic Liquid (Ionic Liquid=[C₂mim][OAc], [MimSO₃H]Cl) (1 g) with 1:10 sample/Ionic Liquid wt ratio. After addition, the vials were covered with a cap, and sealed with Parafilm. The vials were then heated in a temperature-controlled oil bath with magnetic stirring at 80° C. After 24 h, the vials were removed from the oil bath and left to cool on the bench top and recorded observations. A discolored upper phase after reaction indicates extraction of organic matter.

| Reaction System | Before Reaction | After Reaction |
|---|---|---|
| [MimSO₃H]Cl + Rock + in Benzene | Colorless upper | Yellow upper |
| | benzene layer | benzene layer |

| | |
|---|---|
| [C₂mim][OAc] + Rock in Benzene | Colorless upper benzene layer |

### Example 22

Ten (10)-mL borosilicate glass screw-top vials equipped with Teflon coated magnetic stir bar was loaded with Stuart oil shale (0.1 g) and excess of benzene solvent (2 mL) followed by addition of [HN₂₂₂][Al₂Cl₇] (1 g) with 1:10 sample/Ionic Liquid wt ratio and reaction mixture becomes biphasic system contains black lower layer with colorless upper layer. After addition, the vial was covered with a cap, and sealed with Parafilm. The vial was then removed from the glove bag and heated with magnetic stirring in a temperature-controlled oil bath at 80° C. After 24 h, the vials were removed from the oil bath and left to cool on the bench top and reaction mixture becomes biphasic system contains dark black lower layer with yellow color upper (benzene) layer. Later, a small aliquot of the mixture was withdrawn from upper benzene layer of the reaction mixture and analyzed by GC-MS. New peaks were identified in the GC-MS spectrum, indicating presence of organic extracted. After the benzene was evaporated from the liquid phase, the recovered solid represented 21 wt % of the original oil shale.

### Example 23

Ten (10)-mL borosilicate glass screw-top vials equipped with Teflon coated magnetic stir bar was loaded with oil shale (0.1 g) and excess of benzene solvent (2 mL) and reaction mixture becomes mixture of solid and liquid solvent. After addition, the vial was covered with a cap, and sealed with Parafilm. The vial was then heated with magnetic stirring in a temperature-controlled oil bath at 80° C. After 24 h, the vials were removed from the oil bath and left to cool on the bench top. No discoloration was observed in the upper phase (benzene phase). Later, a small aliquot of the mixture was withdrawn from upper benzene layer of the reaction mixture and analyzed by GC-MS. No extra peaks were observed.

### Examples 24-31: Laboratory Scale In Situ Extraction (Mini Rig Core-Flood Experiments)

The following examples describe kerogen mobilization using a high-pressure continuous extraction apparatus (Mini-Rig setup, FIG. 9). The mini-rig setup is a computer-controlled pressure and temperature, flow through system comprised of (i) Vindum Pump 921 (model VP-12K), 12000 psi max, 0.0001-30 ml/min; (ii) a transfer vessel 922 (Piston Reservoir) (500 mL); (iii) two differential pressure regulators 924; (iv) a high-pressure stainless-steel column 923 (30.7 cm long×1.5 internal diameter), 54.2 cc vol.; and (v) a fraction collector 925.

The Vindum pump (model VP-12K) is a screw jack type piston pump displacing a fluid and applying indirect pressure to the bottom of a piston in the transfer vessel. The piston in turn generates pressure on a mobile liquid phase on top of the piston in the reservoir, moving the mobile phase through a packed column (stationary phase) at a controlled flow rate (0.0001-30 mL/min). The mobile phase may then be sent to waste or samples can be collected using the PC controlled fraction collector. The entire system is limited to 2000 psi by the pressure transducers.

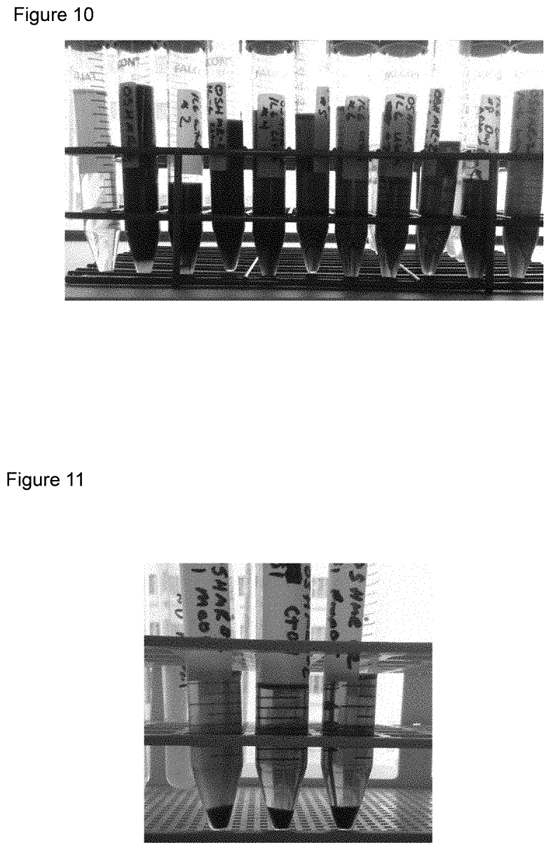

The extraction experiments were conducted with variations of temperature (up to 80° C.±15° C.), soak time, flow rate (0.5-1 mL/min), ionic liquid composition, and source of the oil shale. The purpose of this series of tests was to evaluate the effects of temperature and pressure on extraction efficiencies as well as to provide preliminary validation that the technology can be adapted to a reservoir flood type process. In all instances, varying degrees of kerogen extraction were observed qualitatively as the discoloration of the ionic liquid. FIG. 10 demonstrates a progressive discoloration from black to strong tea colored (left to right) ionic liquid that has passed through a packed oil shale column and subsequently collected by the fraction collector as the experiment progresses. For comparison, a sample of un-used ionic liquid is included on the far left. The color progression is evidence of kerogen extraction.

Aliquots of the recovered ionic liquid samples were taken and the organic extracted fraction was precipitated using an alcoholic solvent (FIG. 11). The precipitate was subsequently combusted in a muffle furnace at 550° C. resulting in a 100% loss on ignition suggesting the precipitate is 100% organic.

### Example 24

A sample of Stuart oil shale was sieved to a mesh size between 500-2000 μm and dried over night at 100° C. The sample was again sieved to remove all fine material <500 μm.

The sample was then slowly packed into the column using an aluminum rod to achieve a uniform pack. The column was preheated to approximately 80° C. A volume of 200 mL [C₈NH₃][Oleate] was poured into the transfer vessel and preheated to 80±15° C. The pump was initially set to deliver a 1 mL/min flow rate. Pressure was monitored in both the pump and the column.

The pressure rose rapidly to 2000 psi once the dead volume in the system filled. A small volume (approx. 2 mL) of black paste eventually extruded out the end of the column. A larger volume (approx. 10 mL) of new [C₈NH₃][Oleate] was bypassed around the column to push the black paste out of the lines. The system was reconfigured for high pressure (bypass pressure transducer) and ramped up to 2500 psi with no additional liquid produced. The system was allowed to remain static over the weekend. The column was then reheated, and pressure ramped to 3300 psi with no additional liquid production.

The test was shut down at that point. When the setup was dismantled, it was observed that the shale on the ionic liquid inlet was blackened and sticky, while the shale on the outlet end was packed very hard and was mostly dry (no ionic liquid). The ionic liquid wet the shale to a column length of approximately 20 cm, the remaining 10 cm was a dry, hard packed shale plug that deformed the steel screen. There was visual evidence of channeling between the steel wall and the shale, and some indications of very small channels in the hard-packed shale.

### Example 25

A sample of Green River oil shale was sieved to a mesh size between 500-2000 μm and dried over night at 100° C. The sample was again sieved to remove fine material <500 μm. The sample was then packed loosely (tapping vertically on the bench) into the mini rig column, to avoid potential plugging as observed in Example 23. The weight of the shale in the column was recorded.

The column was then preheated to approximately 80° C. 200 mL of tributylammonium oleate ([HN₄₄₄][Oleate]) was added to the transfer vessel and heated to 80±15° C. The pump was set to deliver 0.5 mL/min of [HN₄₄₄][Oleate]. Initial produced ionic liquid phase was observed at approximately one pore volume with no pressure build up. The eluent was very black and transitioned to dark tea color over 8 samples, each sample representing the eluent collected per 20 min gradually. The Mini Rig was shut down and the column closed off to allow the shale to soak in the ionic liquid overnight at ambient temperature.

The next day, the column and [HN₄₄₄][Oleate] phase were reheated and the system pressure reactivated. The initial ionic liquid phase was observed slightly darker compared with the previously collected sample (before soaking) and transitioned quickly to a strong tea color.

The column's exit valve was then purposely closed off to build up pressure in the column. At 2000 psi, the valve was slowly opened to release the pressure resulting in a rapid ionic liquid flow; however, the color of the produced ionic liquid remained the same.

The total organics extracted from Green River oil shale with [HN₄₄₄][Oleate] at 80° C. was 5.65 wt % of the total weight of the shale sample, and 24.05 wt % of the total organics as measured using the loss on ignition protocol.

### Example 26

A sample of Stuart oil shale was sieved to a mesh size between 500-2000 μm and dried over night at 100° C. The sample was again sieved to remove all fine material <500 μm. The sample was then packed loosely (tapping vertically on the bench) into the mini rig column. The weight of the shale in the column was recorded.

The ionic liquid [HN₄₄₄][Oleate] was preheated to 80° C.±15° C. and pumped through the pre-heated column (approx. 80° C.) at 0.5 mL/min. A pressure wave of 11 psi was observed to build up as the initial black eluent eluted from the column. The pressure dropped to less than 1 psi after the initial black eluent had passed.

A total of 12 samples were gathered, each sample representing the eluent collected per 20 min gradually, changing in color from opaque black (first sample) to a translucent strong tea color at the end of the test. The waning color indicates that the amount of kerogen being continually extracted lessens throughout the test. The shale pack was allowed to soak overnight in the ionic liquid at ambient temperature and produced a second black eluent on starting up the pump the next day for a total of 16 samples.

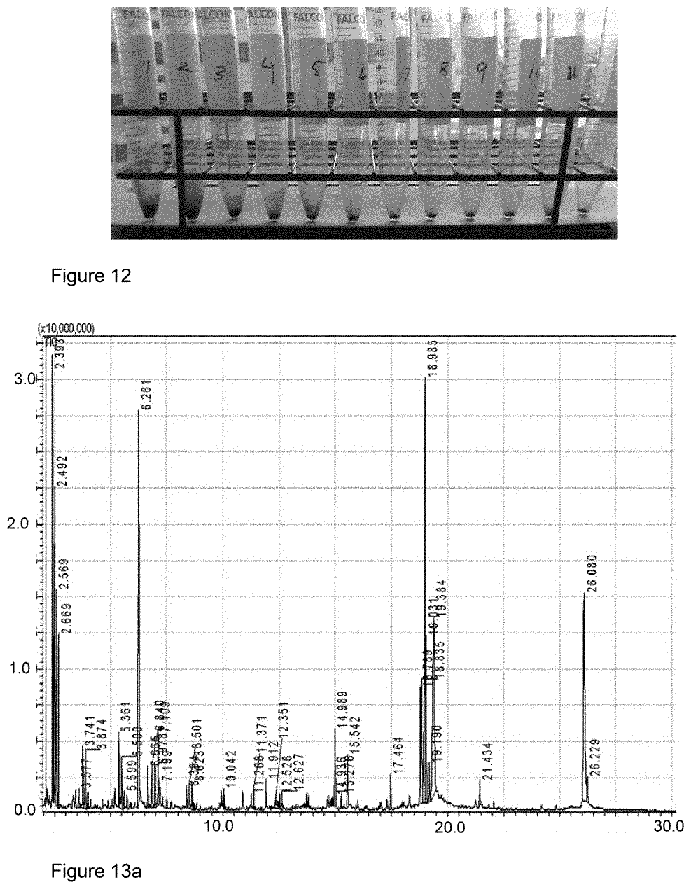

One (1) mL sample of each of the collected fractions was precipitated with ethanol (see picture below). The precipitate was washed twice in ethanol and dried in the oven at 105° C. for 2 h (FIG. 12). The dry weight of each of these produced pellets was then recorded to calculate the total kerogen in each of the collected fractions. The total kerogen extracted from Stuart oil shale (Australia) with [HN₄₄₄][Oleate] at 80° C. was 10.3 wt % of the total weight of the shale sample, and 35.6 wt % of the total organics as measured using the loss on ignition protocol. Loss on ignition of the precipitated kerogen was 100%, indicating no fine mineral particles moved out of the column.

### Example 27

A sample of Stuart oil shale was sieved to a mesh size between 500-2000 μm and dried over night at 100° C. The sample was again sieved to remove all fine material <500 μm. The sample was then packed loosely (tapping vertically on the bench) into the mini rig column. The weight of the shale in the column was recorded.

A 1:1 mixture by weight of [HN₄₄₄][Oleate] and [C₈NH₃][Oleate] was preheated to 80° C.±15° C. and pumped through the pre-heated (approx. 80° C.) column at 0.5 mL/min. A pressure increase up to 32 psi was observed as the initial black eluent came out from the column. The pressure dropped to 10 psi after the black eluent came out and remained constant for the rest of the test.

A total of 14 samples were gathered, each sample representing the eluent collected per 20 min gradually, all of which showed an opaque black color and becoming slightly translucent at the end of the test. The consistent black color suggests increased organic matter extraction as compared with the previous examples. The shale was allowed to soak overnight in the ionic liquid at ambient temperature and produced a second concentrated black eluent on starting up the pump the next day for a total of 19 samples.

One (1) mL sample of each of the collected fractions was precipitated with ethanol. The precipitate was washed twice in ethanol and dried in the oven at 105° C. for 2 h. The dry weight of each of these produced pellets was then recorded to calculate the total kerogen in each of the collected fractions.

The total kerogen extracted from Stuart oil shale (Australia) with the 1:1 mixture by weight of [HN₄₄₄][Oleate] and [C₈NH₃][Oleate] at 80° C. was 15.9 wt % of the total weight of the shale sample, and 54.8 wt % of the total organics as measured using the loss on ignition protocol. Loss on ignition of the precipitated kerogen was 100%, indicating no fine mineral particles moved out of the column.

### Example 28

A 1:1 mixture of Stuart and Green River oil shales was sieved to a mesh size between 500-2000 μm and dried over night at 100° C. The sample was again sieved to remove all fine material <500 μm. The sample was then packed loosely (tapping vertically on the bench) into the mini rig column. The weight of the shale in the column was recorded.

The 61 wt % aqueous solution of tetrabutylammonium dodecylbenzensulfonate ([N₄₄₄₄][C₁₂BenzSO₃]) was preheated to 80° C.±15° C. and pumped through the pre-heated column (approx. 80° C.) at 0.5 mL/min. A pressure increase was observed throughout the test due to a progressive increase in the viscosity of the eluent.

A total of 11 samples were gathered, each sample representing the eluent collected per 20 min gradually, all of which showed an opaque black color throughout the test.

The total organics extracted from the 1:1 mixture of Stuart and Green River Oil Shale with [N₄₄₄₄][C₁₂BenzSO₃] at 80° C. was 3.0 wt % of the total weight of the shale sample, and 11.2 wt % of the total organics as measured using the loss on ignition protocol. Loss on ignition of the precipitated kerogen was 100%, indicating no fine mineral particles moved out of the column.

### Example 29

A sample of Stuart oil shale (Australia) was sieved to a mesh size between 500-2000 μm and dried over night at 100° C. The sample was again sieved to remove all fine material <500 μm. The sample was then packed loosely (tapping vertically on the bench) into the mini rig column. The weight of the shale in the column was recorded.

Oleic acid preheated to 40±15° C. was first pumped through the shale-packed column preheated to approx. 40° C. Three vials of oleic acid were recovered, with almost none discoloration (only slight discoloration was observed, due to presence of fine particulate).

A 1:1 mixture by weight of [HN₄₄₄][Oleate] and [C₈NH₃][Oleate] was preheated to 40° C.±15° C. and pumped through the pre-heated (approx. 40° C.) column at 0.5 mL/min. A slight pressure increase was observed as the initial black eluent came out from the column. The pressure dropped to ambient pressure after the black eluent came out and remained constant for the rest of the test.

A total of 14 samples were gathered, each sample representing the eluent collected per 20 min gradually, all of which remained opaque black color throughout the test, becoming more translucent at the end of the test. The consistent black color suggests kerogen extraction is possible at 40° C. The shale-packed column was allowed to soak over 48 h in the ionic liquid at ambient temperature, after which, both the column and fresh Ionic Liquid mixture was preheated and injected. A second concentrated eluent was obtained, for a total of 19 samples.

One (1) mL sample of each of the collected fractions was precipitated with ethanol. The precipitate was washed twice in ethanol and dried in the oven at 105° C. for 2 h. The dry weight of each of these produced pellets was then recorded to calculate the total kerogen in each of the collected fractions.

The total kerogen extracted from Stuart oil shale with the 1:1 mixture by weight of [HN₄₄₄][Oleate] and [C₈NH₃][Oleate] at 40° C. was 17.4 wt % of the total weight of the shale sample, and 61.2 wt % of the total organics as measured using the loss on ignition protocol. Loss on ignition of the precipitated kerogen was 100%, indicating no fine mineral particles moved out of the column.

### Example 30

A sample of Stuart oil shale (Australia) was sieved to a mesh size between 500-2000 μm and dried over night at 100° C. The sample was again sieved to remove all fine material <500 μm. The sample was then packed loosely (tapping vertically on the bench) into the mini rig column. The weight of the shale in the column was recorded.

A 1:1 mixture by weight of [HN₄₄₄][Oleate] and [C₈NH₃][Oleate] was pumped at ambient temperature (21° C.) through the shale-packed column at 0.5 mL/min. A slight pressure increase was observed as the first drops of the eluent came out from the column. However, the eluent was not dark, remaining honey colored (original Ionic Liquid color) throughout the test.

A total of 9 samples were gathered, each sample representing the eluent collected per 20 min gradually, all of which remained honey colored throughout the test. The shale-packed column was allowed to soak for 48 h in the ionic liquid, after which fresh Ionic Liquid was pumped in. The eluent was observed to be black, confirming that residence time is a factor in optimizing kerogen extraction. A further 5 samples for a total of 14 samples were collected during this test.

One (1) mL sample of each of the collected fractions was precipitated with ethanol. The precipitate was washed twice in ethanol and dried in the oven at 105° C. for 2 h. The dry weight of each of these produced pellets was then recorded to calculate the total kerogen in each of the collected fractions.

The total kerogen extracted from Stuart oil shale (Australia) with the 1:1 mixture by weight of [HN₄₄₄][Oleate] and [C₈NH₃][Oleate] at ambient temperature (21° C.) was 7.7 wt % of the total weight of the shale sample, and 26.6 wt % of the total organics as measured using the loss on ignition protocol.

### Example 31

A sample of Jordanian oil shale was sieved to a mesh size between 500-2000 μm and dried over night at 100° C. The sample was again sieved to remove all fine material <500 μm. The sample was then packed loosely (tapping vertically on the bench) into the mini rig column. The weight of the shale in the column was recorded.

A 1:1 mixture by weight of [HN₄₄₄][Oleate] and [C₈NH₃][Oleate] was pumped at 80° C. through the shale-packed column at 0.5 mL/min. A slight pressure increase (30 psi) was observed as the first drops of the eluent came out from the column and then fell to 5 psi for the rest of test. The column was soaked in ionic liquid solvent for 48 h at ambient temperature.

A total of 19 samples were collected, each sample representing the eluent collected per 20 min gradually. The eluent was observed to be black, confirming that residence time is a factor in optimizing kerogen extraction.

One (1) mL sample of each of the collected fractions was precipitated with ethanol. The precipitate was washed twice in ethanol and dried in the oven at 105° C. for 2 h. The dry weight of each of these produced pellets was then recorded to calculate the total kerogen in each of the collected fractions.

The total kerogen extracted was 6.8 wt % of the total weight of the shale sample, and 28.9 wt % of the total organics as measured using the loss on ignition protocol.

A significant amount of gas was observed to be released after the 48 h soaking time. A Tedlar bag was connected to the output line on the core flood set up and both the effluent and gas were collected for 30 min. The gas phase collected was injected into a GC coupled to a thermal conductivity detector. More than 75% of the collected gas was identified as methane.

### Examples 32-34: Kerogen Precipitation and Light Oil Generation from Mini Rig

### Example 32

The organic material/ionic liquid mixture (2 mL) obtained from Example 30 was transferred into 20 mL glass vials and 8 mL of organic solvents (methanol, 9:1 ethanol:methanol solution, isopropanol, butanol, acetone, and water) were added. The mixture was kept at −20° C. overnight. The precipitate was centrifuged, washed 3 times in methanol and dried in an oven at 90° C. overnight before quantification. The fraction precipitated was for methanol 11.1%, for 9:1 ethanol:methanol solution 3.6%, for isopropanol 0.6%, for butanol 2.6%, for acetone 6.1%, and no precipitation was observed when water was used.

### Example 33

The MIF obtained from Example 2 was pre-dried in the drying oven at 80° C. for 2 h. The dry composite solids resembled a brown filter cake (8.5 g) were then mixed with 75 g of quartz sand in a 100 ml boiling flask (retort flask). The modified Fisher Assay setup (FIG. 4) was used to pyrolyse the sample and the resulting products were analyzed by GC-MS.

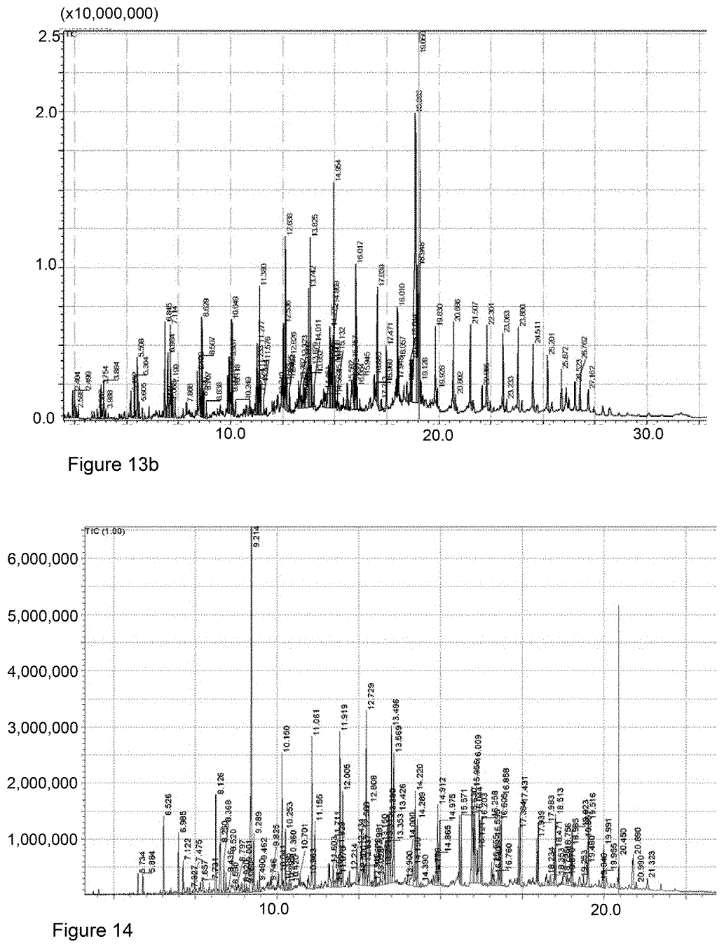

The compounds were identified using the NIST 2014 GC-MS Spectral Library. After pyrolysis, two samples were collected: (i) liquids produced in the receiver, which found to be soluble in dichloromethane; and (ii) condensation generated during pyrolysis which, once the system was cooled down, remained on the quartz sand. Both samples were dissolved in dichloromethane and injected in the GC-MS instrument for analysis (FIG. 13a-b).

FIG. 13a is a GC-MS chromatogram of the produced Shale Oil (Stuart Oil Shale), top) sample recovered from the receiver. FIG. 13b is a GC-MS chromatogram of Shale Oil (reflux) recovered from the quartz sand phase.

The resulting spectra confirmed a hydrocarbon distribution pattern with clusters of peaks increasing by 1 carbon atom per group starting at C8 (bp ˜126° C.) and ending at C32 (bp 470° C.). The presence and molecular distribution of the straight chain alkanes and alkenes observed in the GC-MS analysis of the produced liquids confirms the pyrolysis of large organic molecules.

### Example 34

A composite sample of the first 5 samples collected in examples 26, 27, and 29 (all extracted from Stuart oil shale samples) were mixed together producing 120 mL of Ionic Liquid extract. 380 mL of 90% ethanol was added to the extract and stirred for 15 min, producing a black precipitate. The solution was transferred to 50 mL centrifugation tubes and centrifuged at 3500 rpm for 15 min, producing a roughly 5 mL pellet in each tube. The black supernatant was poured off from the tubes and kept for further processing. The pellets in each of the centrifuge tubes were washed with 10 mL ethanol and centrifuged at 3500 rpm for 15 min.

The produced pellets were dried overnight in a drying oven at 105° C. and were observed to be liquid as they came out of the oven transitioning to wax as they cooled. A total of 2.2 g of precipitate was produced in this manner.

The sample tubes containing the black ethanol-Ionic Liquid mixture were cooled overnight to −20° C., recovering a total of 1.2 g of pellet. The supernatant was additionally cooled to −20° C. for several days and a large fraction of additional precipitate was observed. The supernatant was again decanted and a further 2 g of pellet was collected following the steps above described.

1.2 g of the precipitate was mixed with quartz sand and the mixture was loaded into the MFA setup (FIG. 4). The round bottom flask containing the mixture was heated to approximately 400° C. using a boiling flask heating mantel under a constant nitrogen flow. The retort vessel was insulated to the height of the transfer tube to facilitate the petroleum gas reflux over and into the water-cooled transfer tube (see FIG. 4).

A dense grey vapor was produced that condensed into a reddish light oil visible in the vapor condenser. The test was concluded when no further condensation was observed. A total of 0.9 mL of oil was produced from 1.2 g of kerogen and the quartz sand was observed to be black with coke deposition.

Four samples were taken for GC-MS/Simulated Distillation to characterize potential petroleum products and included samples of the produced oil from the receiver, a dichloromethane wash from the vapor impinger, a dichloromethane wash from the retort and, a dichloromethane extraction of the coked sand. All the samples tested by GC-MS demonstrated the classic alkene/alkane distillation pattern of traditional crude oil samples (FIGS. 14-17).

FIG. 14 is a GC-MS Total Ion Chromatograph of Vapor Impinger Oil.

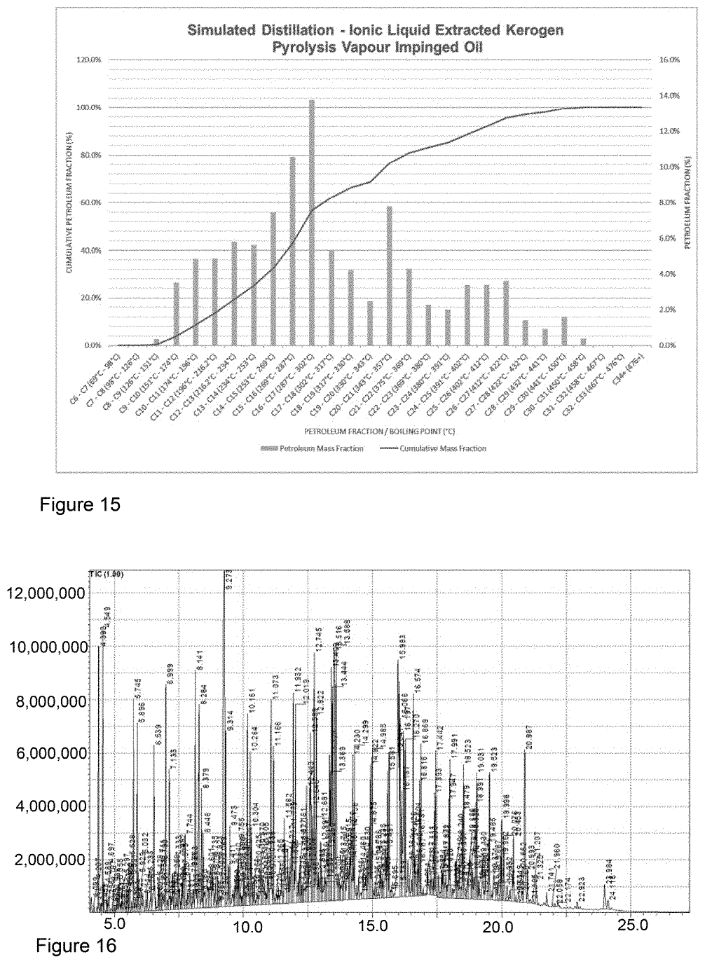

FIG. 15 is a Fraction/Boiling Point Distribution of Vapor Impinger Oil.

FIG. 16 is the GC-MS Total Ion Chromatograph of Produced Oil.

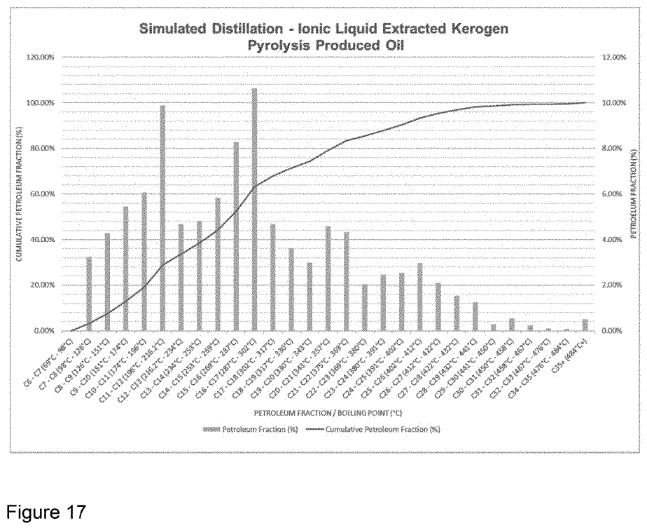

FIG. 17 is the Fraction/Boiling Point Distribution of Produced Oil.

The produced petroleum has a boiling point range covering 98° C. to 484° C. with the 50% volume point falling in the dieseline range (approx. 270° C.) (FIG. 15). Peaks were identified using the NIST 2014 Spectral Library. No compounds containing Sulphur were identified. Additionally, few nitrogen-containing compounds were identified, confirming that most of the Ionic Liquid had been removed from the precipitate prior to pyrolysis.

Although the present invention has been described and illustrated with respect to preferred embodiments and preferred uses thereof, it is not to be so limited since modifications and changes can be made therein which are within the full, intended scope of the invention as understood by those skilled in the art.

1. A process for extracting organic matter insoluble in dichloromethane, toluene and hexane from solids, the process comprising:
combining organic-matter-containing solids and an ionic-liquid-enriched solvent comprising an ionic liquid such that organic matter from the organic-matter-containing solids is transferred into the ionic-liquid-enriched solvent to form a liquid phase comprising the ionic-liquid-enriched solvent and transferred organic matter;
separating the liquid phase from the solid phase; and
recovering the organic matter from the liquid phase.

2. The process according to claim 1, wherein the organic matter comprises kerogen.

3. The process according to claim 1 wherein the organic-matter-containing solids are oil shale.

4. The process according to claim 1, wherein the ionic liquid is stable in the presence of moisture.

5. The process according to claim 1, wherein the combining of the organic-matter-containing solids and an ionic-liquid-enriched solvent is performed at a temperature of in the range of between 20 and 200° C.

6. The process according to claim 1, wherein the combining of the organic-matter-containing solids and an ionic-liquid-enriched solvent is performed at a temperature above the melting point of the ionic liquid.

7. The process according to claim 1, wherein the melting point of the ionic liquid is less than 200° C.

8. The process according to claim 1, wherein the solvent comprises an organic solvent.

9. The process according to claim 1, wherein the solvent comprises one or more of: a hydrogen donor and oxidant agent.

10. The process according to claim 1, wherein the ionic liquid comprises one or more cations selected from the group consisting of:
sulfonium, phosphonium, imidazolium, pyridinium, ammonium.

11. The process according to claim 1, wherein the ionic liquid comprises one or more anions selected from the group consisting of:
halogens;
organic anions containing at least one carboxylic group or at least one sulfonate group;
halides of aluminum, zinc, tin, iron, boron, gallium, antimony, tantalum;
hydrohalogenate, triflate, sulfate, hydrosulfate, fluorinate, phosphate, and organic anions containing a pendant Brønsted-acidic group.

12. The process according to claim 1, wherein the process comprises contacting the organic matter with a swelling agent.

13. The process according to claim 1, wherein the process includes drying the organic-matter-containing solids before combining with the ionic-liquid-enriched solvent.

14. The process according to claim 1, wherein the organic-matter-containing solids is treated with an acid agent before the ionic-liquid-enriched solvent is combined with the organic-matter-containing solids.

15. The process according to claim 1, wherein the process includes combining the solids with an acid to dissolve and recover metals.

16. The process according to claim 1, wherein recovering the organic matter comprises precipitating the organic matter from the liquid phase.

17. The process according to claim 1, wherein the process comprises:
injecting the ionic-liquid-enriched solvent downhole to combine the ionic-liquid-enriched solvent with subsurface organic-matter-containing solids;
pumping the liquid phase to the surface to separate the liquid phase from the solid phase.

18. The process according to claim 1, wherein the process comprises crushing the organic matter containing solids prior to adding an ionic-liquid-enriched solvent.

19. The process according to claim 1, wherein the process comprises crushing the organic-matter-containing solids to particles in a size range of 200-500 microns.

20. The use of a moisture-stable ionic liquid for solubilisation or mobilization of an organic fraction which is insoluble in dichloromethane, toluene and hexane and which is thermally convertible into petroleum products.
